(19) United States
(12) Patent Application Publication
(10) Pub. No.: US 2014/0283728 A1
(43) Pub. Date: Sep. 25, 2014

(54) Take-Off and Landing System for Carrier Aircraft on an Aircraft Carrier and the Method Thereof

(71) Applicant: Lifeng Wang, Spanga (SE)

(72) Inventor: Lifeng Wang, Spanga (SE)

(21) Appl. No.: 14/351,563

(22) PCT Filed: Oct. 15, 2012
(86) PCT No.: PCT/SE2012/000159

§ 371 Date: Apr. 12, 2014

(30) Foreign Application Priority Data
Oct. 13, 2011 (CN) 201110310411.7

(51) Int. Cl. B63B 35/50; B64F 1/04

(52) U.S. Cl. CPC B63B 35/50; B64F 1/04
USPC 114/261

(57) ABSTRACT

The present invention discloses a take-off and landing system for carrier aircraft, which comprises a takeoff device and a landing device; said takeoff device is a bow side launch deck which is located at the front part of the aircraft carrier and extends from a track groove provided with a track guider; said landing device is a stern side rear bridge which is located at the rear part of the aircraft carrier and extends from a treadmill belt-type runway. The invention also discloses a take-off and landing method corresponding to the take-off and landing system. The take-off and landing system and the method thereof enhances advantages and avoids weaknesses with regard to the existing take-off technologies, reduces the difficulty and risk in the existing landing technology. The present invention is suitable for the take-off and landing of all kinds of carrier aircrafts and also makes a design to build a “pocket-sized aircraft carrier” become possible.

### TECHNICAL FIELD

The present invention relates to a technical field of aircraft carrier construction, particularly to a take-off and landing system for carrier aircraft on an aircraft carrier and the method thereof.

### BACKGROUND ART

An aircraft carrier, as a platform for super major weapons, has the power mainly lying in that: it allows a large number of carrier aircrafts to take off from and land on the aircraft carrier in the ocean, and provides a control for a wide range of sea area, by attacking the military targets within the sea area of tens of thousands of square kilometers for offense or resisting attacks from various kinds of weapons in the same vast sea area for defense. So the important basis and one of the key technologies to constitute fighting capacity for a weapon system of aircrafts on the aircraft carrier is a successful take-off and landing of the aircrafts on the aircraft carrier. Hereinafter are respective descriptions for the three stages including takeoff, landing and integration of the carrier aircrafts in the existing technology.

### A. Take-Off Stage

Usually, three basic parameters in relation to the land-based take-off of aircrafts are as follows: 1). thrust-weight ratio, 2). rolling distance, 3). the minimum lift-off safety speed. That is, when an aircraft finishes a certain rolling distance (usually much longer than the length of the aircraft carrier deck) at an acceleration produced by its thrust-weight ratio (ratio of the thrust of an aircraft's engine to the aircraft's weight) for take-off, it reaches the minimum lift-off safety speed. Upon reaching the aforesaid speed, the lift force of the aircraft is equal to the weight of the aircraft, and then the aircraft lifts off.

The formula for an aircraft's lift force is presented as:

Y=½C^{y}σν²S

Y for lift force (unit N)

C^{y} for lift coefficient

ρ for air density (unit kg/m³)

ν for a speed of an aircraft (unit m/s)

S for aircraft wing area (unit m²)

So the lift force of an aircraft is proportional to the square of its speed.

If the aircraft slides at acceleration for a distance which is shorter than the aforesaid distance when it takes off and fails to reach the minimum safety lift-off speed, the lift force produced by the aircraft wings will be less than the weight of the aircraft, so it cannot lift off. Due to the limited length of the flight deck of the aircraft carrier, there are mainly three take-off ways for carrier aircrafts on navy aircraft carriers in the countries all over the world which are vertical take-off (namely the vertical/short range rolling take-off), ski jump take-off (or called sliding-tilted take-off), and ejection take-off (such as steam ejection take-off, electromagnetic ejection take-off).

1. Vertical Take-Off

Vertical take-off utilizes a control over the thrust vector of the carrier aircraft engine to produce a vertical, upward thrust, for realization of take-off.

Since the vertical take-off is depending on the power of the engine of the carrier aircraft itself to vertically push the aircraft upward under a condition where the carrier aircraft is relatively static or has a very slow speed, it requires consumption of a lot of airborne fuel, so this kind of take-off is suitable for the aircraft of small type, small load and short range. At present, this kind of take-off has been rarely used.

2. Ski-Jump Take-Off

For ski jump take-off, the carrier aircraft first rolls at acceleration on the runway of the flight deck of an aircraft carrier only depending on its own power, then it leaps into the air through the upswept deck on the front part of the aircraft carrier, and takes off from the aircraft carrier. The principle is that the upswept angle of the deck (5°˜15°) is regarded as the ejection angle, although the carrier aircraft has not reached the taking off speed yet when it rolls and leaves the aircraft carrier, it rushes out forward for oblique projectile movement after leaving the aircraft which increases the hovering time (equivalent to extending the runway), thereby the aircraft can continue to speed up to reach the taking off speed. However, the hovering time as increased in this way is rather limited, usually a fighter can only take off with half load, and the engine is in the state of thrust augmentation at the time of take-off, thus shortening the aircraft's service life. The fighter is required to be added with some structural weights, such as increasing the wing area, just in order to improve the lift force for realizing the ski jump take-off, while other tactical support aircrafts of various kinds with fixed-wings, such as early warning aircraft, electronic reconnaissance aircraft, anti-submarine aircraft, air tankers are unable to take off. The aircraft carriers in Russia, England, Italy, Spain, India and other countries do not have qualified steam ejections yet due to the technology limitation, thus they can only adopt ski jump take-off. The take-off weight and take-off efficiency of the ski jump take-off are less than that of the ejection take-off, and the combat efficiency thereof is poor than that of the steam catapult.

3. Ejection Take-Off

In addition to its own power, the carrier aircraft further needs forces applied by the catapult to roll for about 100 meters at acceleration on the aircraft carrier, and reach the minimum lift-off safety speed when leaving the aircraft carrier, then climb up to take off depending on its own power. At present, the ejection take-off mainly refers to the steam ejection take-off, and electromagnetic ejection take-off is still under research and development.

Steam catapult appeared in August, 1950 with a prototype developed by Mitchell, a commander of air force reserve for British navy In terms of working principle, steam catapult is to push the pistons by high pressure steam which drives the slider on the ejection track, thus to eject out the carrier aircraft connected to the slider. Until today, only the U.S. has thoroughly grasped the steam catapult technologies, for example, the C-13-1 type steam catapult on the U.S. large aircraft carrier reaches a stroke of 94.6 meters, which can eject out a carrier aircraft with a weight of 36.3 tons at a high speed of 185 knots (that is 339 km/h), thus can satisfy the requirements for take-off of F-14, F-18 fighters and E-2 pre-warning aircraft, etc.

However, the steam catapult has the following defects:

(1) the required ejection force is large, and more work has to be done; the large ejection force is because that the aircraft stops on the take-off line when being ejected, thus in order to achieve high speed from static state, the catapult needs to apply a force up to hundreds of tons; more work to be done is because of the large ejection force and the long journey of doing work (W=F*S), the catapult needs to continue pushing the carrier aircraft to glide at an acceleration for a stroke of about 100 m;

(2) the structure of the catapult is bulky, with a length up to 100 meters (the whole stroke range), which takes much more space in the hull of the aircraft carrier;

(3) the pilot becomes stunned and very uncomfortable at the moment of ejection take-off because of high overload (e.g., 5.8 G);

(4) the energy consumption is large; a steam catapult will usually consume 614 kilograms of steam for one ejection operation; a medium-sized fighter consumes about 1.5-2 tons of fresh water for one ejection; to boil the fresh water into steam also has to consume a huge amount of energy;

(5) the fresh water consumption is large, thereby requiring larger scale self-made fresh water device, water tank, steam gas storage tank and catapult pipeline box, etc., which need to take up more space;

(6) this kind of catapult equipment and auxiliary device with strict seal requirement, high machining accuracy, difficult construction technology and high cost occupy vast space, which not only results in relatively difficult maintenance and usage in normal time, but also is easy to be damaged and hard to be repaired in time of war as a bulky weak part;

In addition, steam catapult has low efficiency, generally between 4% and 6%. The average no critical failure interval is 405 cycles, thus it needs to stop flying and conduct maintenance on the sea or conduct maintenance after returning to the harbor every 3000-3200 times of ejection.

Due to the low efficiency of steam catapult, the U.S. navy has begun with technology research on electromagnetic ejection system since 1982. In the late 1990s, the U.S. navy decides to apply the electromagnetic catapult on a new generation CVN 21 (i.e. Ford level) aircraft carrier. In September of 2009, the electromagnetic catapult project enters the stage of system functional demonstration and validations. In December of 2010, the electromagnetic catapult first successfully conducted ejection take-off test on an F/A-18E carrier fighter. It is expected that “Ford” aircraft carrier will be delivered to the U.S. navy in September of 2015. The steam catapult which has been used on the U.S. aircraft carriers for many years will exit the arena of history. The efficiency of electromagnetic catapult is greatly improved (about 60%). The maintenance staff for the electromagnetic ejection system is decreased by 30% comparing with those for the steam ejection system. Electromagnetic catapult is advantageous over the steam catapult, but still has defects as follows:

(1) the required ejection force is large, and more work has to be done; the catapult applies force on a carrier aircraft stopped on the take-off line in order to make it reach a high speed, thus the required ejection force is large; more work to be done is because of a large ejection force and a long journey of doing work (W=F*S), the catapult needs to continue to push the carrier aircraft to glide at an acceleration for a stroke of about 100 m;

(2) the catapult structure is bulky and rather complex for it has 4 parts including a linear induction motor of about 100 meters long (the horizontal ejection stroke is about 100 meters long), a high-power electric control equipment, a forcing storage device and a power electronic transformation system, which occupy a lot of space in the hull of the aircraft carrier and a large part of the tonnage;

(3) the energy consumption is large; the power consumption for An electromagnetic ejection to take off is still quite large (122 MJ);

(4) the cost for development is expensive; the “Ford” aircraft carrier being constructed in the U.S. is not only expensive, but also too huge in the volume, thus the probability of being hit during the war will be increased accordingly, hence is easy to be damaged and difficult to be repaired;

4. Tackle Take-Off

The Applicant's also put forward a tackle take-off mode which has obtained the patent right for utility model. The technical solution is that a tackle installed with an engine carries the aircraft to slide on the deck track of the aircraft carrier at acceleration, and cast the aircraft upward into the air. Its basic principle is that, in comparison with the carrier aircraft itself, if the proportion of increase in thrust of above tackle-aircraft association is greater than the proportion of increase in the quality, thus the acceleration for sliding on deck will increase, and the end speed (lift-off speed) when finishing slide for a certain distance before leaving the carrier will increase. But in the technology solution, the tackle mechanism is not described in details, unavoidably bringing about various uncertainty and difficulty for implementation of the project technology; Especially, there is no specific restriction on the airborne engine, in the discussion of theoretical basis in practice, the aircraft engine is taken as an example, while research and development on specialized aviation engine faces great challenges of heavy weight, huge volume, and adaptation between tackle and carrier aircraft, as well as braking at the bow, which have become the difficulties of engineering technology application.

B. Landing Stage

1. Current Landing Technology for Aircrafts on the Aircraft Carrier

Usually, the landing of a land-based aircraft is accomplished by five stages: (1) glide; (2) flatten (when the wheel is 2 meters above the ground, throttle back to the idle speed, reduce the glide angle, and exit glide state at the height of 0.5 meters); (3) level flight at a deceleration (minimum level flight speed); (4) fall to touch down (at this moment, the aircraft's speed is decreased to an extent that the lift force is no longer enough to balance the aircraft's weight); (5) roll to land (under the action of wheel friction and air resistance etc., rolling at a deceleration until it halls). However the landing of a carrier aircraft (either ejection or ski jump take-off) is to glide to directly hook the arresting cable on the aircraft carrier (without the above stages of level flight at a deceleration, etc.). A total of 3 or 4 arresting cables are installed on the canted deck of the aircraft carrier, in which the first one is arranged apart from the aft by 55-60 meters, and the remaining ones are arranged at an interval of 6 meters or 14 meters. The height of the arresting cable is 5-20 centimeters or 30-50 centimeters above the deck surface. The carrier aircraft glides from upper right of the stern of the aircraft carrier which is traveling rapidly, hooks the arresting cable with the tail hooker at the aircraft tail, rolls on the deck within 100 meters to brake. The statistics shows that 80% of carrier aircraft accidents occur in the course of touching down onto the carrier but not in the air. The factors attributing to a complicated, difficult and risky landing process for the carrier aircraft is mainly as follows:

1) short on-deck runway; aircraft carrier is limited in length, and the section for the carrier aircraft to land is more limited, while the length of landing area on the aircraft carrier is relevant to the safety in landing of the carrier aircraft;

2) high landing speed; in the existing technology, when directly gliding to touch down onto the carrier, the aircraft shall not throttle back to decelerate, but requires a force appropriately, so that it can immediately go around in case the arresting cable is missing hooked (the statistics of carrier aircraft training shows that, among the four states of safe landing, going around, escaping and crashing into the aircraft, the “going around” is of the largest probability being 40%-50%);

3) the accuracy requirement for predetermined landing point is strict; for the accuracy of the landing point, none of longitudinal, lateral and height errors can be large, otherwise the aircraft may not hook the arresting cable, or may land on the aft or on the right side of the carrier bridge etc., while the carrier aircraft needs to, during gliding at high speed, finish “hitting” the landing position on the deck of the aircraft carrier being moving;

4) control of the gliding angle; generally, a glide angle of 3˜3.5° (3.5˜4°) is preferred; This angle is critical for “the probability of ‘hitting’ the deck”, an angle that is too large will increase the impact on the aircraft, and an angle that is too small will extend the gliding distance. However a glide trace of the carrier aircraft always has a certain deviation from the correct glide curve, which may often present a fluctuation of changes in the curve;

5) alignment with the center line of the runway; in a sense, an alignment is more important than the gliding angle; the runway of the aircraft carrier is very narrow, thus if the aircraft deviates to right, it may hit the superstructure (carrier bridge) of the aircraft carrier, and if the aircraft deviates to left, it may hit other aircraft on the parking apron. So during the landing stage, the carrier aircraft should fly (glide) in a vertical plane where the center line of the landing runway is located; however the center line of the canted deck runway used for landing is not consistent with the heading direction of the aircraft carriers, but presenting an angle of 6˜13° (namely the canted deck and the longitudinal axis of the aircraft carrier form an angle of 6˜13°); this design aims to allow a carrier aircraft rolling after landing so as to avoid other carrier aircrafts which are waiting for take-off at the front part of the carrier, but it also put the carrier aircraft in the course of gliding down to trouble; in order to catch up with the aircraft carrier from behind and fly at a high speed by keeping the same direction with that of the aircraft carrier, it is impossible for the aircraft to fly (gliding down) in the vertical plane where the center line of the canted deck runway, forming an angle of 6˜13° with the heading direction of the aircraft carrier, is located, since when the aircraft is just about to obliquely travel along the direction which forms an angle of 6˜13° with the longitudinal axis of the aircraft carrier, the vertical plane passing through the center line of the canted deck runway has already horizontally moved to right forward; no wonder the American pilots always complain that the canted deck is “escaping from” the landing aircraft.

2. Current Vertical Landing Technology for the Aircraft on an Aircraft Carrier

Similar to the technical field of take-off, there is also vertical landing technology in terms of landing. This technology was suggested in the 1970s when U.K. harrier-type plane appeared, limited to types such as sea harrier and Jacques-38 which are rarely used now. Recently the U.S. F-35 vertical landing is successful in test flight, and is reported as mainly used in the Marine corps; during the war, a special case in which only narrow ground is provided for landing may occur; while F-35 air type still takes off and lands by rolling on land-based airport, and the navy type still mainly adopts an ejection takeoff and a canted deck-arresting cable landing. Since during the vertical landing, the aircraft does not have a level speed, no wing lift is available; it is required to use the vector propulsion technology to produce a great, vertical upward force to “support” the aircraft “hovering” in the air for slow landing, the source of force is the power of the carrier aircraft itself which consumes a lot of airborne fuel. After consumption for vertical take-off, the airborne fuel has been no longer sufficient, and it is still necessary to reserve a large amount of oil to prepare for landing, thus the quantity of bombs carried by the aircraft and the voyage will be inevitably restricted. Moreover, other supporting aircrafts such as attack aircraft and early warning aircraft on the aircraft carrier will not adopt vector propulsion technology, since it's not suitable for vertical take-off and landing. So the vertical take-off and landing technology is not able to smooth over the problems faced by the existing take-off and landing system of the carrier aircraft yet.

3. Regarding the “All-Weather Electronic Aid Landing System”

The Americans invented and researched a series of cutting-edge technologies from the implementation of “Apollo” moon landing plan, in which the precision radar technology, the computer technology, the telemetering and navigating technology, the microwave communication technology and the microelectronic technology and so on have obtained leap development. The Americans applied these technologies to the aircraft carrier to develop an “all-weather electronic landing aid system” which instructs the automatic pilot of the carrier aircraft to automatically correct errors in order for accurate landing.

However, it has been past tens of years since the invention of “all-weather electronic landing aid system” in the 1970s, the U.S. carrier aircraft still relies on pilot training, to a large extent, to ensure landing safety; At the critical moment when the carrier aircraft touches down on the carrier, the operation is still controlled mainly by the pilot with aid of an optical landing aid device. For the degrees of importance, some types of equipments such as the Fresnel lens optical landing aid device, during gliding down for landing of the carrier aircraft, play a much bigger role than a radar; Artificial guide has always been an important means for guaranteeing the safety landing of the carrier aircraft; the adjustment to the terminal of the gliding trace still relies on the experience of the pilots themselves and command of the director on the aircraft; Visual navigation is still considered to be advantageous in low cost, strong autonomy, acquisition of navigation parameters independently from external equipments, and strong anti jamming ability, thus is beneficial to the autonomous landing; Because of this, some attackers and supporting aircrafts among the U.S. second-generation carrier aircrafts have not yet been installed with this set of landing aid equipment.

This may relate to the needs for electromagnetic silent during the war to eliminate the possibility of occurrence of electromagnetic interference, electronic warfare and so on, and more relevant to the difficulty, accuracy of measurement, acquisition and processing of parameters required by the computing center: both the aircraft carrier and the carrier aircraft are in movement with complex relative motions there-between, and the sea is short of landmarks, thus the required flight data acquisition is not comprehensive enough and less precise, and it is also difficult to process the data.

So the improvement, simplification and optimization on the landing technology for a carrier aircraft on an aircraft carrier in terms of kinematics have significance not limited to the requirement of landing operation but more necessary for the convenience and precision of measurement, acquisition and processing of parameters in the all-weather electronic landing aid system, which can be called the premise for establishing a more reliable, all-weather electronic landing aid system.

4. A Runway of the Carrier Aircraft which can Extend Out of the Aircraft Carrier Body

The Applicant once suggested a solution of a runway for the carrier aircraft which can extend out of the aircraft carrier body, and has been applied for a patent of invention in terms of the same, wherein the runway for the carrier aircraft, slidably extending towards the rear side or the rear end of the carrier body, can be used for touching down and landing of the carrier aircraft. However, said runway for the carrier aircraft extending out of the aircraft carrier body in the solution is basically kept a level same with the sea surface, while the flight deck on the aircraft carrier is about 20 meters high above the sea level, thus it is quite difficult to support the runway extending out of the carrier body to such a height by means of a floating boat and several temporary floaters, technically; moreover, to keep it in the level state may not necessarily be most beneficial for landing on the aircraft carrier; additionally, there is no specific descriptions in the solution about perfect anti-shaking preventive measures of a on-deck runway extending out of the carrier for resisting longitudinal, lateral shaking of the aircraft carrier in the sea, wave influence or about cooperation with other aid, braking mechanisms, etc.

C. Aspect of Integration

E. B. Erie, a U.S. pilot, made his plane take off from and land on a warship in 1910 and 1911 successively, for the first time, which starts a history of one hundred years for take-off and landing of the carrier aircraft. He unfortunately lost his life in a landing accident and the aircraft was destroyed, resulting in the carrier aircraft, for a while, landing in the nearby sea surface as a change. Soon, the navy in various countries began trying to arrange two sections of decks on the front and rear part of the aircraft carrier, for the take-off and landing respectively. To prevent the carrier aircraft from hitting the superstructure in the middle of the aircraft carrier when landing, the U.K. navy moves the deck to a side of the aircraft carrier, for the first time, to make it become a straight-through deck. To avoid a rolling carrier aircraft that has been touched down on the rear section deck hitting other aircrafts waiting for take off on the front section deck, Carmel, a U.K. navy captain put forward an idea about canted deck, which is still in use today. The current heavy, medium type aircraft carrier in various countries generally use a two-section (canted and straight) type flight deck, wherein the straight deck is arranged on the front part, used for take off; the canted deck is arranged on the rear part of the aircraft carrier, at the left side of the superstructure and straight deck, with a center line forming an angle of 6°˜13° with the heading direction of the aircraft carrier (namely the canted deck and the longitudinal axis of the aircraft carrier form an angle of 6°˜13° there-between), used for landing. As the flight deck of an offshore platform for take off and landing system of the aircraft carrier, apart from the obviously most essential problem of a short length, there are of course other problems for layout and feasibility, as described below.

1. The length of the flight deck is short. As for the normal take-off and landing of modern jet, even if the flight deck of the largest carrier having a length of 300 meters is still too short. According to the present technology, in order to extend the flight deck, it is forced to increase the displacement of the aircraft carrier, which is accompanied by cost rise and inconvenience in driving and berthing. This obviously is a double-edged sword. The technology has been “stepped back” for several decades since the aircraft carrier was increased up to about 100,000 tons, because the inflection point has arrived by then. If the tonnage is further increased, it will do more harm than good.

2. When the carrier aircraft is landing, it is difficult to align with a center line of the canted deck runway of the aircraft carrier. When the carrier aircraft flies from the behind of the aircraft carrier in the same direction with that of the aircraft carrier to approach the aircraft carrier which is traveling, the flight direction of the aircraft forms an angle of 6°˜13° with a vertical plane where the center line of the landing runway is located; When the aircraft is traveling obliquely at an angle of 6°˜13° with respect to the heading direction of the aircraft carrier, from the right aft of the aircraft carrier, the vertical plane where the center line of the canted deck landing runway is located has already moved to the right with the aircraft carrier traveling forward; As the American pilot always complains, the canted deck is “escaping from” landing aircrafts. It is not easy to fly and glide down to land in the vertical plane where this center line of canted deck runway is located. So in the design scheme of the future U.S. aircraft carrier, a parallel axis of the aircraft carrier is presented; the design in which the landing deck is arranged at the portside of an aircraft carrier has not yet been adopted just because that the deck width is restricted and the range of “heave” of waves at the broadside deck is relatively large.

3. When the carrier aircraft is landing by directly gliding to “fall into” the aircraft carrier, it is also relevant to the landing on the canted deck runway of the aircraft carrier. The landing of a land-based aircraft is accomplished by five stages: glide, flatten, level flight at a deceleration, fall to touch down and roll to stop. Such landing process is quite gentle, the decision and judgment is more convenient for pilots, and requirements for aircraft impact resistance performance can be reduced, etc. U.K. aviation experts also considered the carrier aircraft “touches down by means of ‘flatten’, rather than the usual landing of ‘fall into’ type, under the control of an advanced flight control system . . . ”. The carrier aircraft directly glides to land in a “fall into” manner is designed mainly for the consideration that, the aircraft carrier, as a moving landing platform, the trend of the landing runway thereof is different from the motion direction (forms a certain angle there-between), if a glide trace for landing of the carrier aircraft also includes such stages as “flatten”, “level flight at a deceleration”, “fall to touch down” and so on, the ideal tracking trajectory for carrier aircrafts will be a very complex curve, and at the same time, it also requires the control system to have a higher control ability, which is difficult to realize.

4. The utilization rate for the rear deck of the aircraft carrier is not high. The canted deck of the aircraft carrier is located at the rear portion of the aircraft carrier for landing. There are a total of 4 (or 3) arresting cables installed on the canted deck of the aircraft carrier, in which the first one is arranged apart from the aft by 55-60 meters, then the remaining ones are arrange at an interval of 14 meters (or 6 meters). In order to prevent the carrier aircraft from landing with a low height and hit the stern of the aircraft carrier, the landing point for the aircraft is usually expected to be a position where the second (or even third) arresting cable is hooked, namely the position where the wheels of the carrier aircraft touches the deck, usually more than 70 meters from the stern; taking the braking distance of 100 meters required for stop into account, the length of the landing deck must be more than 190 meters; further taking a turning radius for the aircraft to leave the landing area after braking into account, it will be ended with a total length of more than 200 meters, wherein more than 70 meters thereof are basically unused. Only if the wheels of a carrier aircraft can touch the deck just at the stern, the usability of the deck length can be improved.

5. The front deck of the aircraft carrier has a low utilization rate. The aircraft carrier is as long as about 300 meters, in which, as mentioned above, the canted deck used for landing accounts for more than 200 meters from rear to the front (the length of the landing area for a “Nimitz” class aircraft carrier even increases to 256 meters), thus there are not much deck for take-off left in the front portion of the aircraft carrier. Usually the length of the deck for take-off only can be about 100 meters at most. The take-off rolling is more like a uniformly accelerated motion, thus to make the take-off runway a bit longer is significant for improving the lift-off speed. If the decks at the stern and the rear portion of the carrier can be more effectively used, to make the carrier aircraft braked within 100 meters from the stern after it touches down on the aircraft carrier, leaving some more deck area in the front portion of the aircraft carrier, then the running distance for carrier aircrafts to take off can be appropriately increased, and it's also helpful for other works on deck.

6. During the development of aircraft carrier, as for the above so-called large-scale aircraft carrier whose tonnage has been increased to 10 thousand tons, it seems to reach an inflection point of displacement; the military experts began to rethink a subminiature aircraft carrier, that is the possibility of so-called “pocket aircraft carrier”, which can “launch” aircrafts (the military significance thereof is different from launch of missiles), the body size is small, the stealth performance is good, the mechanism is flexible and agile, the speed is fast, and the cost is low, thus is obviously a very attractive, or very forward-looking idea. The problem also lies in that a flight deck is not long enough. If increasing the deck length, the displacement will be increased according to the current technology, and then the question of how to be “pocket” is occurred.

### CONTENTS OF THE INVENTION

### 1. Technical Problem to be Solved

The technical problem to be solved by the present invention is to provide an aircraft carrier take-off and landing system for aircrafts on an aircraft carrier and the method thereof.

In order to explain the technical problems to be solved by the present invention in a better way, three aspects including takeoff, landing and integration will be described respectively.

A. Aspect of Take-Off

As for the three existing take-off technologies described in the present invention, each of them has both advantages and defects. Among them,

As for said vertical take-off, the force is applied upward, which conforms to the direct purpose of take-off and lift-off, the advantage thereof is “the force is applied upward”, in short; But it has serious problems as follows: the take-off can barely use the lift force of the aircraft wing, and there is no other external forces for aid, thus the weight is balanced merely depending on the aircraft's own power, and a large number of airborne fuel consumption during the take-off will certainly lead to a small size, less bomb load, short range, weak fighting capacity; such shortcoming is short for “the take-off consumes a lot of airborne fuel”.

As for said ski jump take-off, the aircraft leaps into the air forward along a trace of oblique projectile movement when it leaves the aircraft carrier, this increases the time for the aircraft to hover in the air and continue to accelerate, and has an advantage “leap into the air up forward” in short; but the take-off does not obtain external force for aid either, the aircraft rolls on the canted deck runway at the front portion of the aircraft carrier which is 50 or 60 meters long merely depending on the aircraft's own power, the lift-off speed for leaving the aircraft carrier is subjected to a certain negative influence, and the upswept angle of the ramp deck (5°˜15°) applicable for a ski jump take-off is not the ejection angle in physics which can acquire a longer hovering time in the air from the motion of oblique projectile; Anyhow, the time obtained for hovering in the air for accelerating is relatively short, thus the fighter can only take off with half load, while the early warning aircraft and so on is unable to take off; such shortcoming is short for “no external force for aid, short hovering time is relatively shorter”.

As for said ejection take-off, it's aided by external forces applied by the aircraft carrier, which can allow all kinds of carrier aircrafts to take off and has obvious advantages short for “apply external forces for aid”; but since the external forces are applied in the horizontal direction when the aircraft is stopped at the take-off line and are functioning during the entire stroke of about 100 meters; with the aid of the force applied in the horizontal direction, it indirectly, through the horizontal acceleration, improves the vertical upward lift produced by the wings, thus the required external force is very large (as large as several hundreds of tons), the journey for external forces to do work is long (a stroke of 100 meters), hence it has defects such as a lot of work to be done, higher energy consumption, bulky device, occupying a lot of tonnage and space of the aircraft carrier, easy to be damaged during the war, which are short for “the required external force is large, more power, bulky device”.

Therefore, the technical problems to be solved by the invention on take-off aspect is to suggest a new take-off technology for a take-off and landing system of aircrafts on an aircraft carrier. By using this new take-off technology, it can take full advantages of the above three kinds of existing take-off technologies including (1) “the force is applied in an upward direction”, (2) “leap into the air up forward”, (3) “apply external forces for aid”; At the same time, the newly suggest technology can avoid respective defects of above three kinds of existing take-off technologies including: (1) “the take-off consumes a lot of airborne fuel”, (2) “no external force for aid and the time to hover in the air for accelerate is relatively short”, and (3) “the required external force is too large, with more power and bulky device”. In addition, the tackle take-off technology is developed and improved, as an auxiliary part for the new take-off technology.

B. Aspect of Landing

The technical problems to be solved by the present invention is to provide a new landing technology in the take-off and landing system of aircrafts on an aircraft carrier, so that the landing section of the aircraft carrier can be extended to some extent without influencing the displacement, normal traveling and anchoring of the aircraft carrier; the landing speed of carrier aircrafts is obviously decreased, which is beneficial for carrier aircrafts to “hit” the predetermined landing point; it can avoid the complexity of control over the glide angle in the process of gliding to directly land on the aircraft carrier and the related problems; it's beneficial and convenient for an alignment with a center line of the landing runway during the landing process of carrier aircrafts; it can make best use of the advantages and bypass the shortcomings of the technical solution in which the runway for carrier aircrafts is protruding out the aircraft carrier body, and can improve and optimize the same; the improvement, simplification and optimization of the landing technology for carrier aircrafts can be conducted in kinematics, so as to facilitate the simplification and accuracy of parameter measurement, acquisition and processing for all-weather electronic landing aid system; it strengthens the braking function during rolling on the rear portion of the flight deck of the aircraft carrier after carrier aircrafts land on the carrier, so as to make it stops within a distance as short as possible.

C. Aspect of Integration

The present invention aims to comprehensively optimize the coordination and cooperation of a take-off device and landing device in the take-off and landing system of the aircraft carrier in a whole, which intends to: (1) increase the practical length of the runway for carrier aircrafts on the aircraft carrier without amplifying aircraft carrier displacement, increasing tonnage and cost, or causing driving and anchor inconvenient as the price; (2) make a center line of the landing runway parallel to the heading direction of the aircraft carrier, to facilitate the operation of alignment for the center line of the landing runway during landing process of carrier aircrafts; (3) improve the availability of the stern area and the landing area in the rear portion of the aircraft carrier, and facilitate the change from a “glide and fall into” type landing to a “flatten” type landing; (4) simplify or remove bulky ejection mechanism or upswept deck, improve the operation of the flight deck in the middle portion of the aircraft carrier; (5) improve and appropriately expand the bow side take-off area. (6) make a “pocket aircraft carrier” become possible.

### 2. Technical Solution

In order to solve the above-mentioned problems, on one hand, the present invention provides a take-off and landing system for a carrier aircraft on the aircraft carrier, which comprises a takeoff device and a landing device for aircraft positioned on an aircraft carrier; said takeoff device for aircraft is a bow side launch deck which is located at the front part of a flight deck of the aircraft carrier and extends from a track groove provided with a track guider; said landing device for aircraft is a stern side rear bridge which is located at the rear part of the flight deck of the aircraft carrier and extends from a treadmill belt-type runway; said bow side launch deck is a runway deck for ejecting the carrier aircraft up which is positioned at a bow side of the aircraft carrier; said bow side launch deck is slightly longer than a distance between a front wheel and a rear wheel of the carrier aircraft, and slightly wider than a width between a left wheel and a right wheel of the carrier aircraft; the upward ejection force of said bow side launch deck is generated from electromagnetic ejection force, or steam ejection force, or other hydraulic power, pneumatic power and mechanical force; a rear end of said bow side launch deck is extending from a front end of said track groove; said track groove is located beneath the runway deck for the carrier aircraft to take off which is extending from a takeoff line for the carrier aircraft to the rear end of the bow side launch deck; said track guider, either in a convenient guider form or a booster guider form, is fitted in said track groove; said stern side rear bridge is protruding obliquely downwards from the rear part of the on-deck runway of the aircraft carrier towards a rear side of the aircraft carrier, with a distal end of said stern side rear bridge holding on an auxiliary ship, so that a stern side rear bridge is formed; a height above a waterline of the auxiliary ship is slightly lower than that of the aircraft carrier, so that a surface of said stern side rear bridge forms to be a gentle ramp with its front at higher position and its rear at lower position; the empty space on the aircraft carrier, generated after protruding the rear part of the on-deck runway obliquely downward towards a rear side of the aircraft carrier, is filled by ascending an elevating deck to become a new on-deck runway at the rear part of the aircraft carrier; one portion of the rear part of said elevating deck is a treadmill belt-type runway; when viewing vertically downward from the top, a center line of the ramp of the stern side rear bridge is located on an extension line of a center line of the on-deck runway at the rear part of the aircraft carrier and an extension line of a center line of the treadmill belt-type runway; that is, the center line of the ramp of the stern side rear bridge, the center line of the treadmill belt-type runway and the center line of the on-deck runway at rear part of the aircraft carrier are all within the same vertical plane, said vertical plane is parallel to a longitudinal axis of the aircraft carrier; said treadmill belt-type runway in a side view is an upper portion of a closed annular belt; after said upper part ascending with said elevating deck, it is also aligned with said on-deck runway at the rear part of the aircraft carrier; rolling wheels are arranged within said closed annular belt for driving a section of said upper portion which is aligned with the on-deck runway, that is, said treadmill belt-type runway moves backwards at a high speed; said ramp of the stern side rear bridge makes a landing runway for aircraft of the aircraft carrier extending appropriately to the rear part of the aircraft carrier; a termination line for a landing area of the aircraft carrier is positioned at a distance less than 100 meters from the stern of the aircraft carrier, so that the take-off area of the aircraft carrier at its front can be enlarged, and the number and length of take-off runways for carrier aircraft can be increased and/or extended correspondingly.

Preferably, the bow is provided with a plurality (such as 4 pieces) of said bow side launch decks thereon, and a plurality of said track grooves which are corresponding with said bow side launch decks are also arranged (such as 4 pieces); each said bow side launch deck corresponds to a piece of said track groove, or a piece of said bow side launch deck corresponds to two pieces of said track grooves which are close to each other on the bow side in convergence; a cross section of said track groove has a shape of reverse “T”, with a narrower upper part and a wider lower part; a narrow gap in the upper part of an inner chamber of said track groove keeps the whole deck surface basically flat; lubricant is applied on an inner wall of said inner chamber of said track groove; said convenient guider is in a metallic frame structure with a small volume, the cross section of said track guider is smaller than that of said track groove, and also has a shape of reverse “T”; portions where the upper, lower, left and right parts of said track guider are contacting with the inner wall of the inner chamber of said track groove are provided with pulleys or balls, so that said convenient guider is not only limited within said track groove, but can also be guided by the track groove therein to slide forward and backward freely; the portion where an upper portion of said convenient guider protrudes out of the deck surface is a snap-fit mechanism, said snap-fit mechanism is movably connected with a connecting lever projecting downwards from a central portion of a landing gear for double front-wheels of the carrier aircraft; when the carrier aircraft is stand by for take-off on the take-off line, this connection allows the aircraft to be guided straightly forward along the track groove when it is rolling at an acceleration; said booster guider comprises a convenient guider and a lever structure connected to a rear portion of said convenient guider, said lever structure is also fitted in said track groove, the cross section of said lever structure is also slightly smaller than that of said track groove and also has a shape of reverse “T”; portions where the upper, lower, left and right parts of said lever structure are contacting with the inner wall of the inner chamber of said track groove are also provided with pulleys or balls, so that said booster guider is not only limited within said track groove, but can also be guided by the track groove therein to slide forward and backward freely; a portion where an upper portion of the lever structure protrudes out of the deck surface is connected with the booster engine of a small structure; said booster engine is a liquid oxygen-liquid kerosene rocket engine; the portion where an upper front portion of said booster guider protrudes out of the deck surface is a snap-fit mechanism, said snap-fit mechanism is movably connected with a connecting lever projecting downwards from a central portion of a landing gear for double front-wheels of the carrier aircraft; when the carrier aircraft is stand by for takeoff on the takeoff line; this connection allows the aircraft to be guided straightly forward along the track groove when it is rolling at an acceleration by means of a joint promotion of the aircraft engine and the booster engine of said booster guider; a braking device for said track guider is arranged at a portion of a front part of said track groove that is adjacent to said bow side launch deck, when said track guider moves forward to trigger said braking device, said snap-fit mechanism is separated from said connecting lever appropriately, said track guider is braked, said carrier aircraft continues rolling onto said bow side launch deck, the duration time for said bow side launch deck to launch the carrier aircraft upward, starting from the rear wheel of the carrier aircraft rolling upward onto the rear end of said launch deck, ending with the front wheel of the carrier aircraft rolling onto the front end of said launch deck (about tens of milliseconds to a few hundreds of milliseconds), which varies depending on the carrier aircraft; the launch motion of said bow side launch deck is in an upper front direction (or upwards, since the aircraft carrier and the aircraft are all traveling forward at a high speed at this time, the joint vector thereof is also in an upper front direction), and the launch is conducted with a proper pitching angular speed to form a certain upswept angle, namely the lifting height for the front end of said bow side launch deck is slightly higher than that of the rear end; the launching movement of said bow side launch deck is ranged from several centimeters to several meters, depending on the carrier aircraft to be ejected; the upward launching force of said bow side launch deck is larger than the “weight-lift difference”, which is a difference between the weight of the carrier aircraft being stand by for takeoff and the available lift force of the carrier aircraft rolling onto said bow side launch deck at an acceleration; the specific magnitude of the upward launching force applied varies depending on the type of carrier aircraft; so that the carrier aircraft can leap into the air with a better upswept trajectory angle, a higher lift-off speed and a higher vertical upward velocity component, and to realize the take-off.

Preferably, a drive mechanism is positioned within the aircraft carrier body so as to drive the rear part of an on-deck runway of the aircraft carrier to protrude obliquely downwards towards a rear side of the aircraft carrier and to retract; another drive mechanism is also positioned within the aircraft carrier body to drive said elevating deck to ascend and descend appropriately; said drive mechanism drives the rear part of an on-deck runway of the aircraft carrier to protrude obliquely downwards towards a rear side of the aircraft carrier and then forms said stern side rear bridge, so as to extend the on-deck runway of the carrier backwards to some extent; a proximal end of said stern side rear bridge is supported on the aircraft carrier body adjacent to the stern of the aircraft carrier, with a height and balance that can be adjusted appropriately by a controlling mechanism; a spring type or hydraulic type oscillating damper for buffering is positioned between said proximal end of the stern side rear bridge and the aircraft carrier body; a proximal end of the ramp on the surface of the stern side rear bridge is extended from the on-deck runway at the rear part of the aircraft carrier, and further from the rear end of said treadmill belt-type runway on the aircraft carrier; a distal end of said stern side rear bridge is holding on a supporting mechanism of said auxiliary ship; said supporting mechanism has multiple supporting arms so as to support said ramp upward on the stern side rear bridge, an extension and a retraction of a length of said supporting arm is operated by a controlling mechanism, so as to adjust a relative balance for the ramp of said stern side rear bridge; a plurality of arresting cables are arranged on said ramp on the stern side rear bridge; said arresting cables are electromagnetic braking devices or other braking devices which keep the braking process smooth without making the arresting cables imbalance to cause rolling deviations, the magnitude of braking force at both ends of the arresting cable can be accurately adjusted, and the rolling direction of the landing aircraft is modified in time, in order to allow the braked aircraft rolling accurately along a center line of the ramp of the stern side rear bridge; said ramp of the stern side rear bridge is used as a landing runway for aircraft of the aircraft carrier, which is leading to said treadmill belt-type runway on the aircraft carrier and to said rear part of the on-deck runway of the aircraft carrier, from above of said auxiliary ship; said treadmill belt-type runway has a certain degree of flexibility, made of materials with good quality excellent tensile resistance, and the friction coefficient between the surface and the rubber wheels is relatively large; said various driving mechanisms are powered by one portion of a power supply for the aircraft carrier; systems for measuring, sensing and reacting are arranged at an appropriate portion on the stern of said auxiliary ship and/or said aircraft carrier specific to states such as ocean wave, longitudinal and lateral shaking of the aircraft carrier, the measured parameters are input into a computer center, the possible influence on the ramp of said stern side rear bridge and the position at which it should be maintained relatively stable are analyzed and compared, then information is transmitted into the terminal equipment of a supporting mechanism, and instructs the supporting mechanism to ascend and descend automatically, and corrects errors, so as to maintain said ramp of the stern side rear bridge relatively stable when the aircraft is landing; the center line of said ramp of the stern side rear bridge, the center line of said treadmill belt type runway and the center line of said on-deck runway at a rear portion of the aircraft carrier are marked with colors, fluorescence and lights with sharp contrast; a center line pole is arranged at an appropriate position on a center line of the on-deck runway at a rear portion of the aircraft carrier; an indicating system of optics, radar or electronic type for aiding a landing is arranged at an appropriate position on said auxiliary ship and/or the aircraft carrier.

Preferably, the auxiliary ship has independent power, which can support said stern side rear bridge traveling with the aircraft carrier, and appropriately assist said stern side rear bridge with stretching out or retracting; At ordinary time, said stern side rear bridge retracts, while the aircraft carrier and said auxiliary ship are separated from each other, independently traveling and berthing respectively; said auxiliary ship, as one of the members of the aircraft carrier formation, can also additionally take charge of appropriate tasks such as attack, security guards, and supply.

Preferably, a landing area on the flight deck of an aircraft carrier is located at the rear portion of the aircraft carrier, at the left side of a superstructure of the aircraft carrier; an empty area in the middle portion of the flight deck of the aircraft carrier can be used for receiving appropriately increased quantity of aircrafts parking on the flight deck; a take-off area on the flight deck of an aircraft carrier is located at the front portion of the aircraft carrier; a reinforced, enhanced blast pad is arranged behind the take-off line of the take-off runway for the carrier aircraft, used for shielding and protecting from the jet and wake flow from the aircraft engine and the boosting engine of the booster guider.

Preferably, by application of said ramp of the stern side rear bridge, said treadmill belt type runway, etc., the landing area on the aircraft carrier is defined within a limit of about 100 meters from the stern; in the case of remaining a take-off runway of normally about 100 meters long in the front take-off area, a “pocket-sized aircraft carrier” with a shorter length and a smaller displacement can be built, which still maintains the function as an offshore mobile platform for the carrier aircraft.

On the other hand, the present invention provides a method of takeoff and landing for a carrier aircraft on an aircraft carrier, comprising the following steps:

1) the carrier aircraft parking on the deck of the aircraft carrier rolls and reaches at a take-off line, a connecting lever beneath a front landing gear of the carrier aircraft is movably connected with an upper snap-fit mechanism of a track guider, and a blast pad behind the take-off line is raised;

2) the carrier aircraft engine is ignited upon receiving commands for take-off preparation; if a booster guider is used, a booster engine connected thereto is ignited appropriately, then the carrier aircraft starts rolling upon receiving commands for take-off;

3) the carrier aircraft being limited and guided by the track guider rolls forward along a track groove at an acceleration;

4) the carrier aircraft continues to accelerate, and the track guider triggers a braking device positioned at a front part of the track groove when the carrier aircraft finishes the whole running distance and approaches a bow side launch deck;

5) an upper snap-fit mechanism of the track guider is separated from the connecting lever beneath the front landing gear of the carrier aircraft;

6) the track guider brakes;

7) the carrier aircraft continues to accelerate forward so as to roll onto the launch deck with a relatively high speed;

8) the carrier aircraft leaves the aircraft carrier and lifts off, if it has reached an expected lift-off speed which is equal to or higher than a minimum lift-off safety speed;

9) if it has not reached an expected lift-off safety speed yet, the bow side launch deck ejects the carrier aircraft which is rolling forward with high speed forwardly upwards, and the carrier aircraft is ejected at a pitching angular speed required for a flight track angle;

10) the carrier aircraft leaps into the air along a trajectory of oblique projectile movement, at an upswept track angle, in the direction of an upper front resultant vector, leaving the aircraft carrier and lifting off with high speed, then it continues to accelerate to a take-off speed during the subsequent hovering time and finally accomplishes a take-off;

11) before the carrier aircraft is ready for landing, an operator drives an on-deck runway at a rear part of the aircraft carrier to protrude obliquely downwards towards a back side of the aircraft carrier by means of a controlling system, with a distal end holding on a supporting mechanism of an auxiliary ship, so that a stern side rear bridge is formed; the surface of the stern side rear bridge forms to be a gentle ramp with its front at higher position and its rear at lower position; an empty space generated after protruding the rear part of the on-deck runway on the aircraft carrier is filled by ascending an elevating deck to form a new on-deck runway at the rear part of the aircraft carrier; one portion of the rear part of the elevating deck is a treadmill belt-type runway; when viewing from the top, a center line of the ramp of the stern side rear bridge is located on an extension line of a center line of the on-deck runway at the rear part of the aircraft carrier and an extension line of a center line of the treadmill belt-type runway; that is, the center line of the ramp of the stern side rear bridge, the center line of the treadmill belt-type runway and the center line of the on-deck runway at the rear part of the aircraft carrier are all in the same vertical plane; this vertical plane is parallel to the longitudinal axis of the aircraft carrier; the on-deck runway of the aircraft carrier thus can be extended behind the aircraft carrier to some extent;

12) systems for measuring, sensing and reacting, arranged on the auxiliary ship and on the aircraft carrier specific to states such as ocean wave, longitudinal and lateral shaking of the aircraft carrier, are cooperated with a computer center and the supporting mechanism of the ramp on the stern side rear bridge, so as to maintain a balance and relative stability of the ramp on the stern side rear bridge;

13) under the guide of a landing aid system on the auxiliary ship and on the aircraft carrier, at a safety height behind the aircraft carrier, the carrier aircraft accomplishes aligning with the center line of the ramp on the stern side rear bridge, the center line of the treadmill belt-type runway and the center line of the on-deck runway at the rear part of the aircraft carrier, that is, the carrier aircraft flies within a same vertical plane with that of the center line of the ramp on the stern side rear bridge, the center line of the treadmill belt-type runway and the center line of the on-deck runway at the rear part of the aircraft carrier, and travels in the same direction with that of the aircraft carrier;

14) the carrier aircraft glides, flattens (when the wheels of the carrier aircraft have an altitude that is equivalent to about 2 meters above the lower part of the ramp of the stern side rear bridge, the carrier aircraft throttles back to an idle speed, reducing the glide angle; when the wheels have an altitude that is equivalent to about 0.5 meter above the lower part of the ramp of the stern side rear bridge, the aircraft exits the glide state), and level flies horizontally at a deceleration (to reach the minimum level flight speed) with the wings thereof at a critical angle, namely having a largest lift force and largest resistance force; when the carrier aircraft “falls and touches down” on the ramp of the stern side rear bridge (the aircraft is reduced to an extent that the lift is not enough to balance the aircraft's weight), a tail hook of the carrier aircraft hooks an arresting cable, which is an electromagnetic braking device or other braking device with smooth braking process and will not cause gliding errors, so that the carrier aircraft being braked can roll accurately along the center line of the ramp of the stern side rear bridge;

15) the carrier aircraft rolls on the ramp of the stern side rear bridge at a deceleration and lands under the braking actions produced by the arresting cable, the friction force of the wheels, the air resistance and the ramp slope of the ramp of the stern side rear bridge;

16) the carrier aircraft with remaining speed rolls, at a deceleration, onto the treadmill belt-type runway which moves rapidly in a reverse direction, and then the carrier aircraft is braked to halt on the on-deck runway at the rear part of the aircraft carrier under the braking action produced by the friction force of the wheels;

17) after a plurality of carrier aircrafts are landing, the elevating deck is operated to descend to its initial position, and the ramp of the stern side rear bridge, acting as a deck, is separated from the auxiliary ship and driven reversely to be retracted and repositioned on the aircraft carrier.

Wherein, during the above steps of 12)-16), the auxiliary ship, together with the stern side rear bridge, is traveling with the aircraft carrier.

### 3. Beneficial Effects

A. Comparing with Current Ski Jump Take-Off Technology

1. Compared with current ski jump take-off technology, the superior effects of the present invention are mainly presented as follows:

1) aided by the external forces, the carrier aircraft obtains a positive trajectory angle and a positive pitching angular velocity when leaving the aircraft carrier;

2) the lift-off speed for leaving the aircraft carrier is greatly improved;

3) the magnitude of a trajectory angle for leaving the aircraft carrier is adjustable, it can be greater than a fixed angle of 10˜15° of the ramp deck for the ski jump take-off when necessary;

4) the vertical upward component velocity when leaving the aircraft carrier is relatively large.

2. Upon analysis in terms of classical mechanics and kinematics, the superior effects are presented as: the hovering time for an oblique projectile movement depends on its vertical upward component velocity which is set as U and its vertical falling acceleration which is set as I, while the time required for a vertical upward movement or a vertical falling is equal which is set as T and the hovering time is 2T. Namely the hovering time is proportional to the vertical upward component velocity, and is inversely proportional to the vertical falling acceleration I. Wherein

U=IT [symbol] T=U/I (1)

Now we compare the duration length of the hovering time for ski jump with that of the take-off technology in the present invention for analysis: for the convenience of contrast analysis, two carrier aircrafts of the same type, according to the ski jump technology and the technology in the present invention, respectively, depending on its own power, rolls for the same running distance S on the aircraft carrier; then respectively lift off from the upswept deck and the bow side launch deck, at the same positive trajectory angle (an acute angle α) to leave the aircraft carrier; the ski jump take-off has a lift-off speed as Vh, and the lift-off speed to leave from the launch deck is Vb; the vertical upward component velocity to leave the aircraft carrier by ski jump take-off is Uh, Uh=Vh Sin α; the vertical upward component velocity to leave the aircraft carrier by using the launch deck is Ub, Ub=Vb Sin α; According to ski jump take-off technique, the end speed after finishing rolling on the aircraft carrier for an uphill distance as long as S is just its lift-off speed Vh; according to the technology of the present invention, the speed after finishing rolling on the aircraft carrier for a level distance as long as S is Vs, the speed produced by the launch deck to eject the carrier aircraft upward is Vt, and the lift-off speed to leave the aircraft carrier by using the launch deck Vb is a vector sum of Vs and Vt.

Because both of the two aircrafts have the same running distance; according to the present invention, S is the whole journey, while for ski jump take-off, S includes an uphill distance of 50 to 60 meters, so

Vs>Vh (2)

Because Vb is a vector sum of Vs and Vt, when the launch is in forwardly upward direction or upward direction, namely the angle (made by Vs and Vt)≦90°, the vector sum is larger than any one of these two vectors, so

Vb>Vs (3)

From the formula (2) and (3), it is derived that Vb>Vs>Vh, so

Vb>Vh (4)

From the formula (4), we get Vb Sin α>Vh Sin α.

Also, because Uh=Vh Sin α, Ub=Vb Sin α, we get that

Ub>Uh (5)

In the case that usually no other external force is applied, I=g, g for an acceleration of a free falling body; when the above-mentioned carrier aircraft (with a mass of M) leaves the aircraft carrier at a certain trajectory angle (such as α), a certain speed V (and therefore has a certain lift force E) and a certain engine thrust F, the carrier aircraft further has two vertical upward accelerations including a vertical upward component (E/M) COS α of the acceleration (E/M) produced by E and a vertical upward component (E/M) Sin α of the acceleration (F/M)) produced by engine thrust F.

So I=g−(E/M)COS α−(F/M)Sin α (6)

Also because E∝V² (the aircraft lift is proportional to the square of the speed), it can be set that

E=kV² (7)

Eh is set as a lift the carrier aircraft subjected when it leaves the aircraft carrier by ski-jump, Eb is set as a lift the carrier aircraft subjected when it leaves the aircraft carrier from the launch deck.

From the formula (7), we get formula (8) and (9) expressed as:

Eh=kVh² (8)

Eb=kVb² (9)

From the formula (4), we get Eb>Eh (10)

Ih is set as an I value in relation to the above-mentioned carrier aircraft leaves the aircraft carrier by ski jump (a vertical falling acceleration), Ib is set as an I value in relation to the above-mentioned carrier aircraft leaves the aircraft carrier from the launch deck (a vertical falling acceleration).

From the formula (6), we get Ih=g−(Eh/M)COS α−(F/M)Sin α (11)

From the formula (6), we get Ib=g−(Eb/M)COS α−(F/M)Sin α (12)

From the formula (10), (11), (12), we get Ib<Ih (13)

2Th is set as the hovering time for the above-mentioned carrier aircraft after it takes off by ski-jump and leaves the aircraft carrier, 2TB is set as the hovering time for the above-mentioned carrier aircraft leaves the aircraft carrier from the launch deck.

From (1), we get

Th=Uh/Ih (14)

From (1), we get

Tb=Ub/Ib (15)

From the formula (5), (13), (14), (15), we get

Tb>>Th and 2Tb>>2Th (16)

From the above, the hovering time for the carrier aircraft after it leaves the aircraft carrier from the launch deck is greatly longer than the hovering time for the same carrier aircraft when it leaves the aircraft carrier by ski-jump. The extension of hovering time is, in another way, equal to the extension of a take-off runway, which can increase the take-off weight and achieve a higher take-off speed for the carrier aircraft.

It should be pointed out that, in addition to the above fundamental analysis, the present invention also includes more unique technical means, to guarantee, strengthen the take-off effect, and adapt to all kinds of carrier aircrafts. For example:

1) the trajectory angle of the launch deck for ejection in the present invention is adjustable. The positive trajectory angle of the ski-jump take-off is determined by the upswept angle of the huge ski jump deck, which is fixed (set as α);while the angle at which the bow side launch deck in the present invention ejects the carrier aircraft is flexible and controllable, as required. For example it can be set as angle β. In a certain range (α<β), β can be moderately increased to further increase the hovering time;

2) the use of a booster guider increases the thrust-weight ratio and the rolling acceleration of the carrier aircraft for take-off, greatly improves the lift-off speed from the launch deck and increase the hovering time;

3) the expansion of the take-off area and the extension of the take-off deck as mentioned above can also become one of the superimposed factors for improving the lift-off speed of the carrier aircraft from the launch deck and for increasing the hovering time;

4) regarding the current ski jump take-off technology, because there is no track guidance, only one carrier aircraft can take off for each time (one take-off); the present invention provides track guidance, so that a plurality of take-off runways can be arranged in the take-off area, to realize a quick take-off for a group of aircrafts.

B. Comparing with Current Ejection Take-Off Technology

1. The technology by using a bow side launch deck in the present invention mainly has changes as follows, comparing with the current ejection take-off:

1) the point of application of the external force is different: for the launch deck, the external force is applied at the end of the bow side take-off runway of the aircraft carrier; while the application of external force for ejection take-off starts from the beginning point of the take-off runway in the middle of the aircraft carrier.

2) the direction in which the external force is applied is different: the external force applied for the launch deck is in the forwardly upward direction; while the external force applied for the ejection take-off is in the horizontal direction;

3) when external force is applied, the carrier aircraft for the two technologies is in different conditions: when external force is applied for a launch deck, the carrier aircraft has accelerated to finish rolling for the whole stroke and achieve a considerably high speed (and hence has obtained quite a high lift, so the take-off weight of the carrier aircraft has been partly balanced); when external force is applied for an ejection take-off, the carrier aircraft is in a stationary state;

4) the acting distance of the external force is different: the acting distance of the external force applied for a launch deck is ranged from only several centimeters to no more than several meters in upper forward direction; the external force is applied for the traditional ejection take-off over the whole stroke, as long as about 100 meters;

5) the magnitude of the applied external force is different: the external force applied for a launch deck is small, it functions as long as it is larger than the “weight-lift difference” (the difference between the take-off of weight of the carrier aircraft and the obtained lift force when rolling onto said launch deck); ejection take-off has great external forces applied, often as great as hundreds of tons;

6) the work done by the external force and the energy consumption is different: the energy consumption in the present invention is small, while for the ejection take-off device, it is large;

7) the structure, volume and tonnage are different: the take-off device in the present invention is simple and small; the ejection take-off device is complex and bulky;

8) the auxiliary devices: the present invention has auxiliary devices such as a booster guider; the current ejection take-off technology does not have additional devices for aid.

In short, the take-off technology by using a bow side launch deck needs less force and power than the ejection take-off technology, and has a simplified and smaller structure.

2. Regarding the function of a booster guider, hereinafter F/A-18 is taken as an example for supplementary analysis and verification:

F/A-18E

(1) Basic Parameters
1) engine thrust (F): 156.6 KN
two F404-GE-402, 78.3 KN for each engine.
2) maximum take-off weight (M^{j}): 25401 kg
3) running distance for land-based take-off (L): 427 meters
4) acceleration (a): 6.1651 (m/s²)
a=F/M (ignoring the friction and so on)
5) land-based rolling time (t^{l}): 11.7695 s
L=(½)at^{l}^{²} [symbol] t^{l}=\sqrt{2L/a}=11.7695 (s)
6) minimum lift-off safety speed (V^{l}): 72.5603 (m/s)
V^{l}=a t^{l}=72.5603 (m/s), equivalent to 261(km/hour)

(2) the Aircraft can not Lift Off Merely Depending on its Own Engine Thrust
1) the horizontal rolling distance (S) on the aircraft carrier: 110 m
2) rolling time (t^{j}): 5.9736 s
S=(½)at^{l}^{²} [symbol] t^{l}=\sqrt{2S/a}=5.9736 (s)

3) the speed (V^{s}) after finishing the rolling distance (S): 36.8283(m/s)
V^{s}=at^{j}=36.8283 (m/s), equivalent to 132 (km/h)

far from reaching a minimum lift-off safety velocity (V^{l}): 72.5603 (m/s)
4) plus a speed of aircraft carrier (V^{j}): 15.4333 (m/s), equivalent to 55 (km/hour) (30 knots)
1 knot (kn)=1 mile/hour=(1852/3600) m/s, it is an unit for speed
5) lift-off speed (V^{k}): 52.2615 (m/s), equivalent to 188 (km/hour)
V^{k}=V^{s}+V^{j}=36.8283+15.4333=52.2615 (m/s)
6) the difference between the lift-off speed (V^{k}) and the minimum lift-off safety speed (V^{l}) is: 20.2298 (m/s)
V^{l}−V^{k}=72.5603−52.2615=20.2298 (m/s), the aircraft can not lift off

(3) the Cooperation Between the Aircraft and Booster Guider can Realize a Take-Off
1) the combined thrust (F): 396.6 KN
engine thrust (F^{j}): 156.6KN (two F404-GE-402, 78.3*2KN)

liquid oxygen-liquid kerosene rocket engine thrust (F^{h}): 240 KN

F=+F^{j}+F^{h}=156.6+240=396.6 (KN)
2) the mass of the association of the aircraft and the booster guider (M): 26111 (kg)
the maximum take-off weight (M^{j}): 25401 (kg)
the mass of the booster guider for the liquid oxygen-kerosene liquid rocket engine (M^{h}): 710 (kg)
M=+M^{j}+M^{h}=25401+710=26111 (kg)
3) combination acceleration (a): 15.1890 (m/s²)
a=F/M (ignoring the friction and so on)
4) the horizontal rolling distance (S) on the aircraft carrier: 110 m
5) the rolling time (t^{j}) on the aircraft carrier: 3.9048 s
S=(½)at^{l}^{²} [symbol] t^{l}=\sqrt{2S/a}=3.8058 (s)
6) the speed (V^{s}) after finishing a rolling distance S: 57.8064 (m/s)
V^{s}=a t^{j}=57.8064 (m/s), equal to 208 (km/hour)
7) plus a speed of the aircraft carrier (V^{j}): 15.4333 m/s, equivalent to 55 km/hour (30 knots)
1 knot (kn)=1 mile/hour=(1852/3600) m/s, which is an unit for speed.

8) liftoff speed (V^{k}): 73.2397 meters/second, equivalent to 263 kilometers/hour
V^{k}=V^{s}+V^{j}=57.8064+15.4333=73.2397 (m/s)

The lift-off speed (V^{k})=73.2397(m/s), it is larger than the minimum lift-off safety speed (V^{l}) that is 72.5603 (m/s), which allows a direct lift-off for take-off. With such booster guider of simple structure and low energy consumption, it can also produce the same effect as a catapult of huge, complex structure and high energy consumption. The bow side launch deck and the booster guider in the present invention can be independently used or cooperated with each other, to realize the take-off for all kinds of carrier aircrafts.

C. Comparing with Vertical Take-Off and Landing Technical

1. The present invention mainly has improvements comparing with traditional vertical take-off technology as follows:

1) the source for the force applied vertically upward is different: the source of force applied upward in the present invention is an external force applied by the launch deck; while the source of force applied upward for the traditional vertical take-off is the carrier aircraft's own power;

2) the Use of the carrier aircraft wing lift is different: it is better used in the present invention; while is barely available for the traditional vertical take-off;

3) the consumption of airborne fuel is different: it is less in the present invention; while the traditional vertical take-off consumes a large quantity of fuel.

2. Comparing with vertical landing technology

It is essentially the same case as above, comparing with the vertical landing technology. During the vertical landing, the aircraft does not have a level speed, thus no wing lift is available; it is required to use a great, vertically upward force to “support” the aircraft “hovering” in the air for slow landing, with the power of the carrier aircraft itself as the source of external force; it is required to consume a lot of airborne fuel. The present invention also is different from the vertical landing in these aspects. One of the most important aspects is that, it does not have to consume a lot of airborne fuel.

3. The types of aircrafts which can utilize a vertical take-off and landing technology is limited

Since attackers, early warning aircraft and other supporting aircrafts on the aircraft carrier will not adopt vector propulsion technology, they are not suitable for vertical take-off and landing. The present invention is adapted to take-off and landing for various kinds of carrier aircrafts, and also presents notable beneficial effects.

D. Comparing with Current Canted Deck Landing Technology

1) Increase in the length of landing runway in practices. The security of a landing for the carrier aircraft is considerably influenced by the deck length. However the increase in the length of an aircraft carrier will cause an increase in tonnage and cost, accompanied by the inconvenience of action and berthing, which is not desirable. The present invention has a stern side rear bridge like a “transformer” which can be stretched out and retracted, thus increasing the deck length of the aircraft carrier and the safety during landing without influencing tonnage, cost, action, and berthing of the aircraft carrier.

2) The landing speed is significantly reduced. Compared with the “gliding for landing” in the existing technology (the glide speed is usually more than 250 kilometers per hour) in which the aircraft shall not throttle back to decelerate but requires a force in order to immediately pull up and go around in case a landing is failed (the probability of go around is even higher than the probability of safe landing); however, in accordance with the present invention, when the carrier aircraft “falls to touch down” after level flight at a deceleration (reduced to minimum level flight speed, usually the minimum level flight speed is only about one hundred kilometers per hour, e.g., F-15: 122 km/h, F-16: 135 km/h), the aircraft speed relative to the ramp deck of the stern side rear bridge is, in fact, similar with the normal speed of a vehicle, because the aircraft carrier has a speed of about 55 km/h in the same direction, which has to be subtracted from the speed value. So in this case, not only the control for a landing at such a relatively low speed is easier and the landing security is improved, but also the braking overload endured by arresting cables and the tail hook is greatly reduced (since after the arresting cable will sweep across the deck after broken by the hook, accidents where the aircraft is destroyed and pilots are killed occur frequently, so in the U.S. military regulations, the arresting cable and tail hook have to be replaced after being used for 3, 4 times and 50 times, respectively), which also increases their utilization rate.

3) Facilitating the carrier aircraft to “hit” the predetermined landing point during a landing. According to the existing landing technology, the carrier aircraft glides and “falls into” a certain point in a moving plane on the sea from a high altitude (the second arresting cable on the canted deck of the aircraft carrier), which is hard to aim, thus errors in longitudinal, lateral and height direction are inevitable. As for the landing technology proposed in the present invention, before landing, the carrier aircraft level flies at the sea level with a height of about 0.5-2 meters above the lower part of the ramp of the stern side rear bridge, to follow the aircraft carrier; the ramp of the stern side rear bridge is like a “target” hanging right ahead of the carrier aircraft, it's easy to accurately “aim”. According to the U.S. naval provisions, when the carrier aircraft is landing, the aircraft carrier's pitching angle may not exceed 2°, the rolling angle may not exceed 7°, and the sinking distance of the stern shall not be longer than 1.5 meters. Under such sea conditions where the shaking amplitude is small (and even more smooth), with the sway of the aircraft carrier and the heave of the waves are not very fast (for example the pitching period for a “nimitz” class aircraft carrier is about 25 seconds), it is feasible for maintaining a balance and relative stability of the ramp on the stern side rear bridge, by means of a system for measuring, sensing and reacting arranged on the auxiliary ship and on the aircraft carrier specific to states such as ocean wave, pitch and roll of the aircraft carrier cooperated with a computer center and a supporting mechanism of the ramp on the stern side rear bridge. So in the design scheme for future U.S. aircraft carrier, a parallel axis of aircraft carrier is presented; the design in which the landing deck is arranged at the portside of an aircraft carrier has not yet been adopted just because that the deck width is restricted and the range of “heave” of waves at the broadside deck is relatively large. A slight “lift and sink” of the larboard of a giant aircraft carrier, like a ten thousands of tons, is also difficult to balance or stabilize, but for the a runway stretching out to the sea (like a very long cantilever of a crane), the weight is quite light, thus in modern technology conditions, it will be possible to control the relative balance and stability thereof. Moreover, the carrier aircraft also obtains a certain lift when landing on the so-called ramp of the stern side rear bridge (still has remaining velocity), which can balance part of the aircraft's weight; furthermore, the carrier aircraft's sinking is not fast, the auxiliary ship has both passive buoyancy for support (for example, when the whole weight of a carrier aircraft is put on a aircraft carrier of about 20 meters wide, and 50 to 60 meters long, the aircraft carrier only sinks for about 1 cm) and active reaction from supporting arms, even if the landing point on the aircraft carrier has a minor change, the carrier aircraft has passed the landing point for quite a long distance before such change without causing any unfavorable influence.

4) To avoid the problems concerning the glide angle in the existing technology during landing process. When landing according to the existing technology, the glide trajectory of the carrier aircraft often has a certain deviation from the correct glide trace, presenting a fluctuation of change in the curve; the glide angle (usually 3°˜3.5°, or 3.5°˜4°) is not only critical for “the probability of ‘hitting’ the deck”, but also critical for the impact force of landing and the gliding distance. The carrier aircraft in the present invention “falls to touch down” during the stage of “level flight to deceleration”, there is no need of complex control over glide angle. According to the current landing technology, a landing of “directly glide to touch down” has some problems concerning the glide angle, one of which is that the sinking of the carrier aircraft is too fast. Usually a land-based aircraft has a certain glide angle at the moment of “falls to touch down” after the stage of “level flight to deceleration” at a height of 0.5˜2 m from the ground, but this glide angle is much less than that for a usual glide to touch down for the carrier aircraft. A land-based standard, sinking speed is 3 m/s, usually less than half of the sinking speed when the corresponding carrier aircraft directly glides to touch down according to the current landing technology; According to the present invention, the glide angle for the carrier aircraft when it “falls to touch down” after the stage of “level flight to decelerate” is similar to that during above-mentioned landing process of a land-based aircraft or even a bit smaller because its landing point moves forward due to traveling of the aircraft carrier. Therefore, according to the present invention, when the aircraft is touching down on the aircraft carrier, the sinking speed of the latter is equal to or lower than the land-based standard, sinking speed (about 3 m/s), which is lower than half of the sinking speed for the corresponding carrier aircraft to directly glide to touch down according to the existing technology. So the weight increase in the structure (such as a landing gear), resulted from the touch down (e.g., at a high sinking speed) of the carrier aircraft in order to adapt to the present technology can be reduced to some extent; such weight increase is also one of the reasons why the tactical performance and technical performance of the carrier aircraft are greatly decreased compared with other land-based aircraft of the same type.

5) It's beneficial and easy for an alignment with a center line of the landing runway during the landing process. A runway on the aircraft carrier is very narrow, if the aircraft is not well aligned with the center line, it may hit other aircraft on the bridge and parking apron or may fail to land on the aircraft carrier and drop into the sea. The center line of the canted deck of the current heavy, medium type aircraft carrier in various countries used for “fall to touch down” is not consistent with the heading direction of the aircraft carrier (the longitudinal axis of the aircraft carrier) but having an angle of 6°˜13° there-between. When the carrier aircraft, from behind, in the same direction, flies and approaches the aircraft carrier which is traveling forward, it is not located within the vertical plane where the central line of the landing runway of the canted deck is located; if the carrier aircraft flies (glides) at an angle of 6°˜13° with respect to the heading direction of the aircraft carrier from the rear side of the aircraft carrier, the vertical plane where the central line of the landing runway of the canted deck is located has instantly moved to the right, along with the traveling aircraft carrier, thus it is difficult to align there-with. However in the present invention, the central line of the rear part of the flight deck and the central line of the ramp of the stern side rear bridge are all on the longitudinal axis of the aircraft carrier and in the same direction with the heading direction of the aircraft carrier; in this case, when a carrier aircraft flies at a safety height from the behind of the aircraft carrier, it begins to move into the vertical plane where the center lines are located by adjustment, and continues with the adjustment to remain in this vertical plane where the center line of the landing runway is located for a subsequent period of time (glide, flatten, level flight to decelerate) which is long enough for it approaches the aircraft carrier traveling forward in the same direction (this is not difficult, because the aircraft carrier is very huge in volume and weight, thus during straightly forward movement at high speed, it only has a little deviation of small radian; the carrier aircraft, by contrast, is much smaller and more flexible, thus is easy to maintain in this vertical plane during straightly forward movement), until it “falls to touch down” on the center line of the ramp of the stern side rear bridge, then the aircraft hooks the arresting cables; since the carrier aircraft was inherently good at alignment, and the electromagnetic brake device, etc. provides a smooth braking process without missing balance of the arresting to cause rolling deviation, the magnitude of braking force at both ends of the arresting cable can be accurately adjusted, to timely adjust the rolling direction of the landing aircraft, so that the braked aircraft can accurately roll onto the aircraft carrier along the center line of the ramp of the stern side rear bridge at a deceleration, and is braked until stop along a center line of the treadmill belt type runway and a center line of the rear part at the flight deck of the aircraft carrier.

6) It facilitates a convenience and precision for parameter measurement, acquisition and processing of an all-weather electronic landing aid system. To replace the canted deck with the “ramp of stern side rear bridge-treadmill belt type runway” as the landing runway, to replace the “glide to ‘fall into’” type landing with a “level flight to decelerate” landing, to decrease the landing speed, to make the trend of the landing runway aligning with the heading direction of the aircraft carrier, to make it easy for an alignment with the center line of the landing runway during landing process, etc., so that the landing technology for carrier aircraft on an aircraft carrier is improved, simplified and optimized in terms of kinematic.

7) It decreases a braking distance of rolling onboard. After landing, the wheel friction of a land-based aircraft is one of the mechanisms which allow it rolling for several hundred meters at a deceleration until stop. When the carrier aircraft that brakes by means of wheel friction is rolling on the treadmill belt type runway, the distance by which the latter rapidly “takes out” towards the stern, is equivalent to the braking distance of the carrier aircraft. After leaving the treadmill belt type runway, the carrier aircraft is very little in remaining speed, and can be braked to stop within a short distance.

E. Comparing with the Layout of the Current Aircraft Carrier Flight Deck

1) The practical utilization rate for a landing area on the flight deck of the aircraft carrier is improved. On the canted deck for the carrier aircraft to land in the existing technology, the first arresting cable is located apart from the aft by 55-60 meters, then the remaining ones are arrange at an interval of 14 meters. For consideration of safety, the carrier aircraft usually selects to hook the second or third arresting cable, in this way, a space of about 70 meters long from the landing point to the stern is generated, which is not used effectively; in the present invention, during the carrier aircraft's landing process, the wheels touch the landing area on the flight deck of the carrier from the stern, thus no unused space left.

2) It Increases the length of the usable runway, moreover, the ramp of the stern side rear bridge can be retracted in normal time without influencing the traveling and berthing of the aircraft carrier.

3) The rear deck of the aircraft carrier is provided with a treadmill belt type runway.

4) The vertical plane through the center line of the ramp of the stern side rear bridge, the vertical plane where the center line of the treadmill belt type runway is located and the vertical plane where the center line of the on-deck runway at the rear portion of the aircraft carrier are the same plane.

5) The termination line of the landing area for the carrier aircraft can be arranged within a distance of 100 meters from the stern (due to significantly decreased landing speed, the action of the ramp on the stern side rear bridge and the action of the treadmill belt type runway, the carrier aircraft can be braked within this area safely).

6) The operation region in the take-off area is large enough.

7) Launch decks are arranged at the bow, at the front end of the take off runway, track grooves are arranged beneath the take-off runway deck and a track guider is placed (a convenient guider or a booster guider) in the track groove, with each launch deck corresponding to one track groove or two track grooves which are close to each other in convergence at the front end thereof. In this way, a huge canted deck of 50, 60 meters long can be removed, and it's no need to arrange a huge catapult beneath the take-off runway deck.

8) The empty area left in the middle part of the flight deck of the aircraft carrier is used for improving the operations on deck, such as appropriately increasing the number of aircrafts parking on the flight deck.

9) The stern side rear bridge extends the landing runway towards the rear side of the aircraft carrier, and the landing area on the aircraft carrier can be limited within a distance of about 100 meters from the stern, with a take-off runway of about 100 meters in the take-off area at the front part, thus the length of the aircraft carrier can be significantly shortened, and the displacement is decreased, which makes a “pocket aircraft carrier”, as a mobile platform for aircraft on the sea with small body, good stealth performance, excellent mechanical flexibility, fast speed and low cost, become possible.

### BRIEF DESCRIPTION OF THE DRAWINGS

FIG. 1 is a top view of a take-off and landing system for a carrier aircraft on an aircraft carrier of the present invention;

FIG. 2 is a side view of a take-off and landing system for a carrier aircraft on an aircraft carrier of the present invention;

FIG. 3 is a front view of the cross section of a track groove of the present invention;

FIG. 4 is a front view of the cross section of a track groove and of a track guider therein of the present invention;

FIG. 5 is a side view of a convenient track guider of the present invention;

FIG. 6 is a side view of a booster track guider of the present invention.

In which: 1: aircraft carrier; 2: carrier aircraft; 3: track groove; 4: take-off line; 5: bow side launch deck; 7: take-off area; 8: landing area; 10: stern side rear bridge; 11: center line of the ramp of the stern side rear bridge; 12: arresting cable; 13: treadmill belt-type runway; 14: on-deck runway at the rear part of the aircraft carrier; 15: center line of the on-deck runway at the rear part of the aircraft carrier; 16: termination line of the landing area; 18: auxiliary ship; 19: waterline; 20: supporting mechanism; 21: belt wheels of the treadmill belt-type runway; 24: deck surface; 25: inner chamber of the track groove; 26: track guider; 27: pulley; 28: snap-fit mechanism; 29: lever structure; 30: booster engine; 31: superstructure; 32: blast pad.

### SPECIFIC MODE FOR CARRYING OUT THE INVENTION

Hereinafter the present invention will be described in details in conjunction with the appended drawings and the examples.

### Example 1

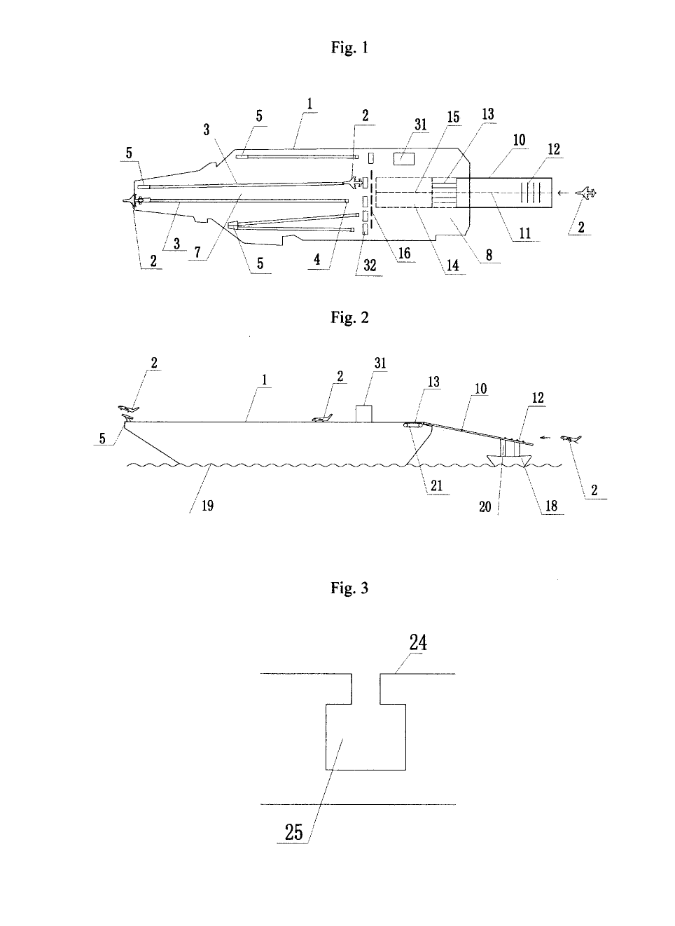

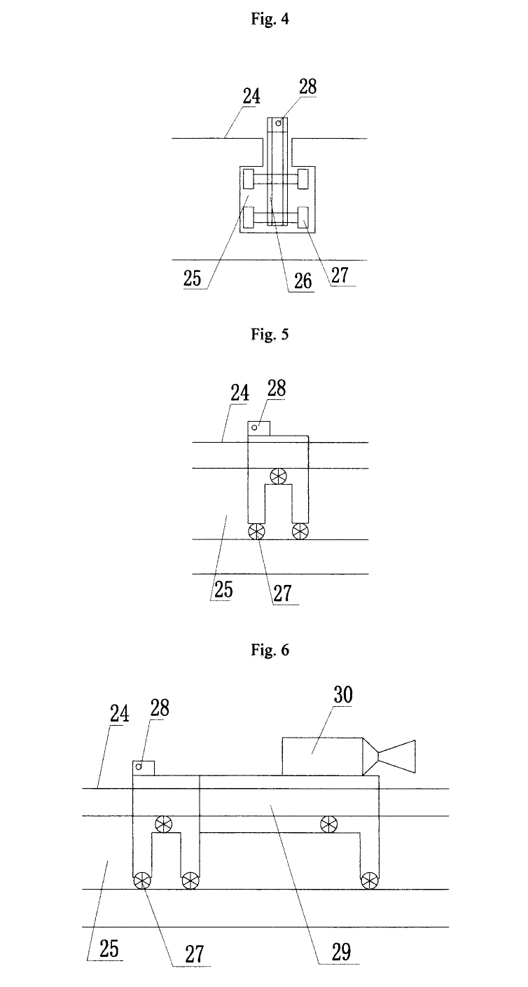

As shown in FIGS. 1-6, said bow side launch deck 5 is a runway deck for ejecting the carrier aircraft 2 upward and positioned at a bow side of the aircraft carrier 1; said bow side launch deck 5 is slightly longer than a distance between a front wheel and a rear wheel of the carrier aircraft 2, and slightly wider than a width between a left wheel and a right wheel of the carrier aircraft 2; the upward ejection force of said launch deck 5 is generated from an electromagnetic ejection force, or a steam ejection force, or other hydraulic power, pneumatic power and mechanical force; a rear end of said bow side launch deck 5 is extending from a front end of said track groove 3; said track groove 3 is located in a take-off area 7 of the aircraft carrier 1, beneath a runway deck for the carrier aircraft 2 to take off which is extending from a take-off line 4 for the carrier aircraft 2 to the rear end of the bow side launch deck 5; said track guider 26 is fitted in an inner chamber 25 of said track groove 3, said track guider 26 is a convenient guider as shown in FIG. 5 or a booster guider as shown in FIG. 6.

Wherein, the bow is provided with a plurality of said bow side launch decks 5 thereon, such as 4 launch decks, and a plurality of said track grooves 3 which are corresponding with said bow side launch decks 5 are also arranged, such as 4 track grooves 3; each bow side launch deck 5 corresponds to a track groove 3, or a bow side launch deck 5 corresponds to two track grooves 3 which are close to each other on the bow side in convergence; a cross section of said track groove 3 has a shape of reverse “T”, with a narrower upper part and a wider lower part; a narrow gap in the upper part of the inner chamber 25 of said track groove 3 keeps the whole deck surface 24 of the aircraft carrier 1 basically flat; lubricant is applied in the inner chamber 25 of said track groove 3; said convenient guider is in a metallic frame structure with a small volume, the cross section of said track guider 26 is slightly smaller than that of said track groove 3, and also has a shape of reverse “T”; portions where the upper, lower, left and right parts of said track guider 26 are contacting with the inner wall of the inner chamber 25 of said track groove 3 are provided with pulleys 27 or balls, so that said convenient guider is not only limited within said track groove 3, but can also be guided by the track groove 3 therein to slide forward and backward freely; the portion where an upper portion of said convenient guider protrudes out of the deck surface 24 is a snap-fit mechanism 28, said snap-fit mechanism 28 is movably connected with a connecting lever projecting downwards from a central portion of a landing gear for double front-wheels of the carrier aircraft 2, when the carrier aircraft 2 is stand by for take-off on the take-off line 4, this connection allows the aircraft 2 rolling straightly forward along the track groove 3 at an acceleration; said booster guider comprises said convenient guider and a lever structure 29 connected to a rear portion of said convenient guider, said lever structure 29 is also fitted in the inner chamber 25 of said track groove 3, the cross section of said lever structure 29 is also slightly smaller than that of said track groove 3 and also has a shape of reverse “T”; portions where the upper, lower, left and right parts of said lever structure 29 are contacting with the inner wall of the inner chamber 25 of said track groove 3 are also provided with pulleys 27 or balls, so that said booster guider is not only limited within said track groove 3, but can also be guided by the track groove 3 therein to slide forward and backward freely; a portion where an upper portion of the lever structure 29 protrudes out of the deck surface 24 is connected with the booster engine 30 of a small structure, said booster engine 30 is a liquid oxygen-liquid kerosene rocket engine; the portion where an upper front part of said booster guider protrudes out of the deck surface 24 is a snap-fit mechanism 28, said snap-fit mechanism 28 is movably connected with a connecting lever projecting downwards from a central portion of a landing gear for double front-wheels of the carrier aircraft 2, when the carrier aircraft 2 is stand by for take-off on the take-off line 4, this connection allows the aircraft 2 rolling straightly forward along the track groove 3 at an acceleration by means of a joint promotion of the carrier aircraft 2 engine and the booster engine 30 of said booster guider; a braking device (not shown) for said track guider is arranged at a portion of a front part of said track groove 3 adjacent to said bow side launch deck 5, when said track guider moves forward to trigger said braking device, said snap-fit mechanism 28 is separated from said connecting lever appropriately, said track guider is braked, and said carrier aircraft 2 continues rolling onto said bow side launch deck 5.

Wherein, the duration time for said bow side launch deck 5 to launch the carrier aircraft 2 upward, staring from the rear wheel of the carrier aircraft 2 rolling upward onto the rear end of said launch deck 5, ending with the front wheel of the carrier aircraft 2 rolling onto the front end of said launch deck 5, about tens of milliseconds to a few hundred milliseconds, varies depending on the carrier aircraft 2; the launch motion of said bow side launch deck 5 is in an upper front direction (or upwards, since the aircraft carrier 1 and the carrier aircraft 2 are all traveling forward at a high speed at this time, the joint vector thereof is also in an upper front direction), and the launch is conducted with a proper pitching angular speed to form a certain upswept angle, namely the lifting height for the front end of said bow side launch deck 5 is slightly higher than that of the rear end; the ejecting movement of said bow side launch deck 5 is ranged from several centimeters to several meters, depending on the carrier aircraft 2 to be ejected; the upward ejection force of said bow side launch deck 5 is larger than the “weight lift difference”, which is a difference between the weight of the carrier aircraft 2 being stand by for takeoff and the available lift force of the carrier aircraft 2 rolling onto said bow side launch deck 5 at an acceleration; the specific magnitude of the upward launching force applied varies depending on the type of carrier aircraft 2; so that the carrier aircraft 2 can leap into the air with a better upswept trajectory angle, a higher lift-off speed and a higher vertical upward velocity component, and to realize the take-off.

Said stern side rear bridge 10 is protruding obliquely downwards from the rear part of the on-deck runway of the aircraft carrier 1 towards a rear side of the aircraft carrier, with a distal end of said stern side rear bridge 10 holding on an auxiliary ship 18, so that a stern side rear bridge 10 is formed; a height above a waterline 19 of the auxiliary ship 18 is slightly lower than that of the aircraft carrier 1, so that a surface of said stern side rear bridge 10 forms to be a gentle ramp with its front at higher position and its rear at lower position; an empty space, generated after protruding the rear part of the on-deck runway on the aircraft carrier 1 obliquely downwards towards a rear side of the aircraft carrier 1, is filled by ascending an elevating deck which was at a lower position to become the on-deck runway 14 at the rear part of the aircraft carrier 1; one portion of the rear part of the elevating deck is a treadmill belt-type runway 13; as shown in FIG. 2, said treadmill belt-type runway 13 in a side view is an upper portion of a closed annular belt, after said upper part ascending with said elevating deck, it is also aligned with the on-deck runway 14 at the rear part of the aircraft carrier 1; as shown in FIG. 1, when viewing vertically downward from the top, a center line 11 of the ramp of the stern side rear bridge 10 is located on an extension line of a center line 15 of the on-deck runway 14 at the rear part of the aircraft carrier 1 and an extension line of a center line of the treadmill belt-type runway 13; that is, the center line 11 of the ramp of the stern side rear bridge 10, the center line of the treadmill belt-type runway 13 and the center line 15 of the on-deck runway 14 at rear part of the aircraft carrier 1 are all within the same vertical plane, said vertical plane is parallel to a longitudinal axis of the aircraft carrier 1; rolling wheels 21 are arranged within said closed annular belt for driving a section of said upper portion which is aligned with the on-deck runway 14, that is, said treadmill belt-type runway 13 moves backwards at a high speed.

Wherein, a drive mechanism is positioned within the aircraft carrier 1 body so as to drive the rear part of an on-deck runway of the aircraft carrier 1 to protrude obliquely downwards towards a rear side of the aircraft carrier 1 and to retract; a drive mechanism is also positioned within the aircraft carrier 1 body to drive said elevating deck to ascend and descend appropriately; said drive mechanism drives the rear part of an on-deck runway of the aircraft carrier 1 to protrude obliquely downwards towards a rear side of the aircraft carrier 1 and then forms said stern side rear bridge 10, so as to extend the on-deck runway of the aircraft carrier 1 backwards to some extent; a proximal end of said stern side rear bridge 10 is supported on the aircraft carrier 1 body adjacent to the stern of the aircraft carrier 1, with a height and balance that can be adjusted appropriately by a controlling mechanism; a spring type or hydraulic type oscillating damper for buffering is positioned between said proximal end of the stern side rear bridge 10 and the aircraft carrier 1 body; a proximal end of the ramp on the surface of the stern side rear bridge 10 is extended from the on-deck runway at the rear part of the aircraft carrier 1, and further from the rear end of said treadmill belt-type runway 13 on the aircraft carrier 1; a distal end of said stern side rear bridge 10 is holding on a supporting mechanism 20 of said auxiliary ship 18; said supporting mechanism 20 has multiple supporting arms so as to support said ramp upward on the stern side rear bridge 10, an extension and a retraction of a length of said supporting arm is operated by a controlling mechanism, so as to adjust the relative balance for the ramp of said stern side rear bridge 10; a plurality of arresting cables 12 are arranged on said ramp on the stern side rear bridge 10, said arresting cables 12 are electromagnetic braking devices or other braking devices which keep the braking process smooth without making the arresting cables 12 imbalance to cause rolling deviations, the magnitude of braking force at both ends of the arresting cable 12 can be accurately adjusted, and the rolling direction of the landing carrier aircraft 2 is modified in time, in order to allow the braked carrier aircraft 2 rolling accurately along a center line 11 of the ramp of the stern side rear bridge 10; said ramp of the stern side rear bridge 10 is used as a landing runway for carrier aircraft 2 of the aircraft carrier 1, which is leading to said treadmill belt-type runway 13 on the aircraft carrier 1 and to said rear part of the on-deck runway 14 of the aircraft carrier 1 from above of said auxiliary ship 18.

Wherein, said treadmill belt-type runway 13 has a certain degree of flexibility, made of materials with good quality, excellent tensile resistance, and the friction coefficient between the surface and the rubber wheels is relatively large.

Wherein, said various driving mechanisms are powered by one portion of a power supply for the aircraft carrier 1.

Wherein, systems for measuring, sensing and reacting are arranged at an appropriate portion on the stern of said auxiliary ship 18 and/or said aircraft carrier 1 specific to states such as ocean wave, longitudinal shaking and lateral shaking of the aircraft carrier 1, the measured parameters are input into a computer center, the possible influence on the ramp of said stern side rear bridge 10 and the position at which it should be maintained relatively stable are analyzed, compared, then information is transmitted into the terminal equipment of said supporting mechanism 20, instructs the supporting mechanism 20 to ascend and descend automatically, and corrects errors, so as to maintain said ramp of the stern side rear bridge 10 relatively stable when the aircraft 2 is landing; the center line 11 of said ramp of the stern side rear bridge 10, the center line of said treadmill belt type runway 13 and the center line 15 of said on-deck runway 14 at a rear portion of the aircraft carrier 1 are marked with colors, fluorescence and lights with sharp contrast; a center line pole is arranged at an appropriate position on a center line 15 of the on-deck runway 14 at a rear portion of the aircraft carrier 1; indicating systems of optics, radar and electronic type for aiding a landing is arranged at an appropriate position on said auxiliary ship 18 and/or the aircraft carrier 1.

Wherein, the auxiliary ship 18 has independent power, which can support said stern side rear bridge 10 traveling with the aircraft carrier 1, and appropriately assist said stern side rear bridge 10 with stretching out or retracting; said auxiliary ship 18, as one of the members of the aircraft carrier 1 formation, can also have appropriate tasks such as fighting, security guards, supply, etc.

Wherein, the take-off area 7 of the flight deck of an aircraft carrier 1 is located at the front portion of the aircraft carrier 1; a reinforced, enhanced blast pad 32 is arranged behind the take-off line 4 of the take-off runway for the carrier aircraft 2, used for shielding and protecting from jet and wake flow of the carrier aircraft 2 engine and the boosting engine 30 of the booster guider; the landing area 8 on the flight deck of an aircraft carrier 1 is located at the rear portion of the aircraft carrier 1, at the left side of a superstructure 31 of the aircraft carrier 1; since the landing runway of the above-mentioned aircraft carrier 1 has been extended effectively by means of said stern side rear bridge 10 while the landing speed of the carrier aircraft 2 is effectively decreased, as well as the application of said treadmill belt type runway 13, etc., the terminate line 16 of the landing area is within a limit of about 100 meters from the stern of the aircraft carrier 1; in the case of remaining a take-off runway of normally about 100 meters long in the front take-off area 7, a “pocket-sized aircraft carrier” with a shorter body and a smaller displacement can be built, which still maintains the function as an offshore mobile platform for the carrier aircraft 2 of an aircraft carrier 1.

### Example 2

A method used for takeoff and landing of a take-off and landing system for a carrier aircraft on an aircraft carrier as described in the present invention comprises the following steps:

Step 1: the carrier aircraft 2 parking on the deck of the aircraft carrier 1 reaches at a take-off line 4, a connecting lever beneath a front landing gear of the carrier aircraft 2 is movably connected with an upper snap-fit mechanism 28 of a track guider, and a blast pad 32 behind the take-off line 4 is raised;

Step 2: the carrier aircraft 2 engine is ignited upon receiving commands for take-off preparation; if a booster guider is used, a booster engine 30 connected thereto is ignited appropriately, then the carrier aircraft 2 starts rolling upon receiving commands for take-off;

Step 3: the carrier aircraft 2 being limited and guided by the track guider rolls forward along a track groove 3 at an acceleration;

Step 4: the carrier aircraft 2 driven by an carrier aircraft 2 engine and a booster engine 30 of a booster guider continues to accelerate, and the track guider 26 triggers a braking device positioned at a front part of the track groove 3 when the carrier aircraft 2 finishes the whole running distance and approaches a bow side launch deck 5;

Step 5: an upper snap-fit mechanism 28 of the track guider 26 is separated from the connecting lever beneath the front landing gear of the carrier aircraft 2;

Step 6: the track guider 26 brakes;

Step 7: the carrier aircraft 2 continues to accelerate forward so as to roll onto the bow side launch deck 5 with a relatively high speed;

Step 8: the carrier aircraft 2 leaves the aircraft carrier 1 and lifts off, if it has reached an expected lift-off speed, which is equal to or higher than a minimum lift-off safety speed;

Step 9: if it has not reached an expected lift-off safety speed yet, the bow side launch deck 5 ejects the carrier aircraft 2 which is rolling forward with high speed forwardly upwards, and the carrier aircraft 2 is ejected at a pitching angular speed required for a flight track angle;

Step 10: the carrier aircraft 2 leaps into the air along a trajectory of oblique projectile movement, at an upswept track angle, in the direction of an upper front resultant vector, leaving the aircraft carrier 1 and lifting off with high speed, then it continues to accelerate to a take-off speed during the subsequent hovering time and finally accomplishes a take-off;

Step 11: before the carrier aircraft 2 is ready for landing, an operator drives an on-deck runway at a rear part of the aircraft carrier 1 to protrude obliquely downwards towards a back side of the aircraft carrier 1 by means of a controlling system, with a distal end holding on a supporting mechanism 20 of an auxiliary ship 18, so that a stern side rear bridge 10 is formed, the bridge surface of the stern side rear bridge 10 forms to be a gentle ramp with its front at higher position and its rear at lower position; an empty space generated after protruding the rear part of the on-deck runway 14 on the aircraft carrier 1 is filled by ascending an elevating deck at a lower position to form a new on-deck runway 14 at the rear part of the aircraft carrier 1; one portion of the rear part of the elevating deck is a treadmill belt-type runway 13; when viewing from the top, a center line 11 of the ramp of the stern side rear bridge 10 is located on an extension line of a center line 15 of the on-deck runway 14 at the rear part of the aircraft carrier and an extension line of a center line of the treadmill belt-type runway 13; that is, the center line 11 of the ramp of the stern side rear bridge 10, the center line of the treadmill belt-type runway 13 and the center line 15 of the on-deck runway 14 at the rear part of the aircraft carrier 1 are all in the same vertical plane, this vertical plane is parallel to the longitudinal axis of the aircraft carrier 1; the on-deck runway 14 of the aircraft carrier 1 thus can be extended behind the aircraft carrier 1 to some extent;

Step 12: systems for measuring, sensing and reacting, arranged on the auxiliary ship 18 and on the aircraft carrier 1 specific to states such as ocean wave, longitudinal shaking and lateral shaking of the aircraft carrier 1 are cooperated with a computer center and the supporting mechanism 20 of the ramp on the stern side rear bridge 10, so as to maintain a balance and relative stability of the ramp on the stern side rear bridge 10;

Step 13: under the guide of a landing aid system on the auxiliary ship 18 and on the aircraft carrier 1, at a safety height behind the aircraft carrier 1, the carrier aircraft 2 accomplishes aligning with the center line 11 of the ramp on the stern side rear bridge 10, the center line 13 of the treadmill belt-type runway 13 and the center line 15 of the on-deck runway 14 at the rear part of the aircraft carrier 1, that is, the carrier aircraft 2 flies within a same vertical plane with that of the center line 11 of the ramp on the stern side rear bridge 10, the center line 13 of the treadmill belt-type runway 13 and the center line 15 of the on-deck runway 14 at the rear part of the aircraft carrier 1, and travels in the same direction with that of the aircraft carrier 1;

Step 14: the carrier aircraft 2 glides, flattens (when the wheels of the carrier aircraft 2 have an altitude that is equivalent to about 2 meters above the lower part of the ramp of the stern side rear bridge 10, the carrier aircraft 2 throttles back to an idle speed, reducing the glide angle; when the wheels have an altitude that is equivalent to about 0.5 meter above the lower part of ramp of the stern side rear bridge 10, the carrier aircraft 2 exits the gliding state), and flies horizontally at a deceleration (to reach a minimum level flight speed) with the wings thereof at a critical angle, namely having a largest lift force and largest resistance force; when the carrier aircraft 2 “falls and touches down” on the ramp of the stern side rear bridge 10 (the aircraft's speed is reduced to an extent that the lift force is not enough to balance the aircraft's weight), a tail hook of the carrier aircraft 2 hooks an arresting cable 12, which is an electromagnetic braking device or other braking device with smooth braking process and will not cause any gliding errors, so that the carrier aircraft 2 being braked can roll accurately along the center line 11 of the ramp of the stern side rear bridge 10;

Step 15: the carrier aircraft 2 rolls on the ramp of the stern side rear bridge 10 at an deceleration and lands under the braking actions produced by the arresting cable 12, the friction force of the wheels, the air resistance and the ramp slope of the ramp of the stern side rear bridge 10;

Step 16: the carrier aircraft 2 with remaining speed rolls, at an deceleration, onto the treadmill belt-type runway 13 which moves rapidly in a reverse direction, and then the carrier aircraft 2 is braked to halt on the on-deck runway 14 at the rear part of the aircraft carrier 1 under the braking action produced by the friction force of the wheels;

Step 17: after a plurality of carrier aircrafts 2 are landing, the elevating deck is operated to descend to its initial position, and the ramp of the stern side rear bridge 10, acting as a deck, is separated from the auxiliary ship 18 and driven reversely to be retracted and repositioned on the aircraft carrier 1;

Wherein, in the above-mentioned steps 12)˜16), the auxiliary ship 18, together with the stern side rear bridge 10, is traveling with the aircraft carrier 1.

As shown in FIGS. 1-6, in order to coordinate and cooperate with the take-off device and landing device in the take-off and landing system of the aircraft carrier 1 in example 1, the present invention can further optimize the layout of the flight deck of the aircraft carrier 1.

The landing area 8 of the flight deck is within a limit of 100 meters from the stern of the aircraft carrier 1; the take-off area 7 of the flight deck is moderately enlarged or the length of the aircraft carrier 1 is moderately shortened with remaining the original length of the take-off area 7.

Wherein, the landing runway for the carrier aircraft 2 is extended toward the stern rear part of the aircraft carrier 1, that is, the ramp of the stern side rear bridge 10, on which the arresting cables 12 are arranged; a reinforced region for wheel friction braking is arranged at appropriate positions of the on-deck runway 14 at a rear part of the aircraft carrier 1, namely the treadmill running belt type runway 13; a termination line 16 of the landing area 8 for the carrier aircraft 2 is arranged within a distance of 100 meters from the stern of the aircraft carrier 1.

Wherein, at ordinary time, the stern side rear bridge 10 is retracted, which will not influence traveling and berthing of the aircraft carrier 1.

Wherein, the middle part and the front part of the flight deck of the aircraft carrier 1, as an increased and enlarged take-off area 7, can appropriately extend the length of the take-off runway (within 200 meters), accompanying with appropriately increased number of take-off runways; or, the length of the aircraft carrier 1 can be moderately shortened with remaining the original length of the take-off area 7, to design and build a “pocket-sized aircraft carrier”.

Wherein, a bow side launch deck 5 is arranged at the bow part at the front end of the take-off runway, a track groove 3 and a track guider 26 (convenient guider or booster guider) is provided beneath the take-off runway deck with each bow side launch deck 5 corresponding to a track groove 3 or corresponding to more than two track grooves 3 which are close to each other at the front end thereof in convergence.

Wherein, the empty area in the middle part of the flight deck of the aircraft carrier 1 can allow appropriate increase in the number of aircrafts parking on the flight deck.

The above embodiments are only used for describing the present invention, but not for limiting the scope thereof. Without departing from the spirit and scope of the present invention, a person skilled in the art can further make various changes and modifications thereto, therefore all equivalent technical solutions also fall into the extent of the present invention. The scope of protection of the present invention shall be defined by the appending claims.

What claimed is:

1. A take-off and landing system for carrier aircraft on an aircraft carrier, characterized in that, it comprises:
a takeoff device and a landing device for aircraft positioned on an aircraft carrier; said takeoff device for carrier aircraft is a bow side launch deck which is located at the front part of a flight deck of the aircraft carrier and extends from a track groove provided with a track guider; said landing device for aircraft is a stern side rear bridge which is located at the rear part of the flight deck of the aircraft carrier and extending from a treadmill belt-type runway; said bow side launch deck is a runway deck for ejecting the carrier aircraft up which is positioned at a bow side of the aircraft carrier; said bow side launch deck is longer than a distance between a front wheel and a rear wheel of the carrier aircraft, and wider than a width between a left wheel and a right wheel of the carrier aircraft; a rear end of said bow side launch deck is extending from a front end of said track groove; said track groove is located beneath the runway deck for the carrier aircraft to take off which is extending from a takeoff line for the carrier aircraft to the rear end of the bow side launch deck; said track guider is fitted in said track groove; said stern side rear bridge is protruding obliquely downwards from the rear part of the on-deck runway of the aircraft carrier towards a rear side of the aircraft carrier, with a distal end of said stern side rear bridge holding on an auxiliary ship; a height above a waterline of the auxiliary ship is slightly lower than that of the aircraft carrier, a surface of said stern side rear bridge forms to be a gentle ramp with its front at higher position and its rear at lower position; a center line of the ramp of the stern side rear bridge and a center line of the runway at rear part of the aircraft carrier are within the same vertical plane, said vertical plane is parallel to a longitudinal axis of the aircraft carrier; said treadmill belt-type runaway is located at the rear part of an elevating deck, said elevating deck is used for filling an empty space generated after protruding the rear part of the on-deck runway obliquely downward towards a rear side of the aircraft carrier; said treadmill belt-type runway is an upper portion of a closed annular belt, and rolling wheels are arranged within said closed annular belt for driving a section of said upper portion which is aligned with the on-deck runaway; a termination line in a landing area of the aircraft carrier is positioned at a distance less than 100 meters from the stern of the aircraft carrier.

2. The take-off and landing system for a carrier aircraft on an aircraft carrier of claim 1, characterized in that, the bow is provided with a plurality of said bow side launch decks thereon, and a plurality of said track grooves which are corresponding with said bow side launch decks are also arranged; a cross section of said track groove has a shape of reverse “T”, with a narrower upper part and a wider lower part; lubricant is applied on an inner wall of an inner chamber of said track groove; a cross section of said track guider is smaller than that of said track groove, and also has a shape of reverse “T”, portions where the upper, lower, left and right parts of said track guider are contacting with the inner wall of the inner chamber of said track groove are provided with pulleys or balls; said track guider comprises a convenient guider and a booster guider; the portion where an upper portion of said convenient guider protrudes out of the deck surface is a snap-fit mechanism, said snap-fit mechanism is movably connected with a connecting lever projecting downwards from a central portion of a landing gear for double front-wheels of the carrier aircraft, when the carrier aircraft is stand by for takeoff on the takeoff line; said booster guider comprises a convenient guider and a lever structure connected to a rear portion of said convenient guider, said lever structure is also fitted in said track groove; a portion where an upper portion of the lever structure protrudes out of the deck surface is connected with the booster engine; a braking device for said track guider is arranged at a portion of a front part of said track groove that is adjacent to said bow side launch deck.

3. The take-off and landing system for a carrier aircraft on an aircraft carrier of claim 1, characterized in that, a drive mechanism is positioned within the aircraft carrier body so as to drive the rear part of an on-deck runway of the aircraft carrier to protrude obliquely downwards towards a rear side of the aircraft carrier, and to retract the same; a proximal end of said stern side rear bridge is supported on the aircraft carrier body adjacent to the stern of the aircraft carrier, a spring type or hydraulic type oscillating damper for buffering is positioned between said proximal end of the stern side rear bridge and the aircraft carrier body; a proximal end of the ramp on the surface of the stern side rear bridge is engaged, aligned and jointed with the on-deck runway at the rear part of the aircraft carrier, and extending from the rear end of said treadmill belt-type runway on the aircraft carrier; a driving mechanism is also positioned within the aircraft carrier body so as to drive said elevating deck to ascend and descend appropriately; a distal end of said stern side rear bridge is holding on a supporting mechanism of said auxiliary ship; said supporting mechanism has multiple supporting arms so as to support said ramp on the stern side rear bridge, an extension and a retraction of said supporting arm is operated by a controlling mechanism; a plurality of arresting cables are arranged on said ramp on the stern side rear bridge, said arresting cables are electromagnetic braking devices; said various driving mechanisms are powered by one portion of a power supply for the aircraft carrier; systems for measuring, sensing and reacting are arranged at a portion on the stern of said auxiliary ship and/or said aircraft carrier specific to states such as ocean wave, longitudinal shaking and lateral shaking of the aircraft carrier; a center line pole is positioned at a center line of the on-deck runaway at a rear portion of the aircraft carrier; an indicating system of optics, radar or electronic type for aiding a landing is arranged at a rear portion of said auxiliary ship and/or said aircraft carrier.

4. A method of takeoff and landing for a carrier aircraft on an aircraft carrier, characterized in that, it comprises the following steps:
1) the carrier aircraft parking on the deck of the aircraft carrier rolls and reaches at a take-off line, a connecting lever beneath a front landing gear of the carrier aircraft is movably connected with an upper snap-fit mechanism of a track guider, and a blast pad behind the take-off line is raised;
2) the carrier aircraft engine is ignited upon receiving commands for take-off preparation, wherein a booster guider is used to boost the ignition appropriately, then the carrier aircraft starts rolling upon receiving commends for take-off;
3) the carrier aircraft being limited and guided by the track guider rolls forward along a track groove at an acceleration;
4) the carrier aircraft continues to accelerate, and the track guider triggers a braking device positioned at a front part of a track groove when the carrier aircraft finishes the whole running distance and approaches a bow side launch deck;
5) an upper snap-fit mechanism of the track guider is separated from the connecting lever beneath the front landing gear of the carrier aircraft;
6) the track guider brakes;
7) the carrier aircraft continues to accelerate forwards so as to roll onto the bow side launch deck with a relatively high speed;
8) the carrier aircraft leaves the aircraft carrier and lifts off, if it has reached a lift-off safety speed;
9) if it has not reached an expected lift-off safety speed yet, the bow side launch deck ejects the carrier aircraft forwardly upwards, and the carrier aircraft is ejected at a pitching angular speed required for a flight track angle;
10) the carrier aircraft leaps into the air along a trajectory of oblique projectile movement, at an upswept track angle, in the direction of forwardly an upper front resultant vector, leaving the aircraft carrier and lifting off with high speed, then it continues to accelerate to a take-off speed during the subsequent hovering time and finally accomplishes a take-off;
11) before the carrier aircraft is ready to land, an operator drives a on-deck runway at a rear part of the aircraft carrier to protrude obliquely downwards towards a back side of the aircraft carrier by means of a controlling system, with a distal end holding on a supporting mechanism of an auxiliary ship, so that a stern side rear bridge is formed; the surface of the stern side rear bridge forms to be a gentle ramp with its front at higher position and its rear at lower position; an empty space generated after protruding the rear part of the on-deck runway on the aircraft carrier is filled by ascending an elevating deck to form a new on-deck runway at the rear part of the aircraft carrier; one portion of the rear part of the elevating deck is a treadmill belt-type runway; when viewing from the top, a center line of the ramp of the stern side rear bridge is located on an extension line of a center line of the on-deck runway at the rear part of the aircraft carrier and an extension line of a center line of the treadmill belt-type runway; the on-deck runway of the aircraft carrier thus can be extended behind the aircraft carrier;
12) systems for measuring, sensing and reacting, arranged on the auxiliary ship and on the aircraft carrier specific to states such as ocean wave, longitudinal and lateral shaking of the aircraft carrier, are cooperated with a computer center and the supporting mechanism of the ramp on the stern side rear bridge, so as to maintain a balance and relative stability of the ramp on the stern side rear bridge;
13) under the guide of a landing aid system on the auxiliary ship and on the aircraft carrier, at a safety height behind the aircraft carrier, the carrier aircraft accomplishes aligning with the center line of the ramp on the stern side rear bridge, the center line of the treadmill belt-type runway and the center line of the on-deck runway at the rear part of the aircraft carrier, that is, the carrier aircraft flies within a same vertical plane with that of the center line of the ramp on the stern side rear bridge, the center line of the treadmill belt-type runway and the center line of the on-deck runway at the rear part of the aircraft carrier, and travels in the same direction with that of the aircraft carrier;
14) the carrier aircraft glides, flattens, then level flights at a deceleration, with the wings thereof at a critical angle which allows a largest lift force and a largest resistance force; when the carrier aircraft falls and touches down on the ramp of the stern side rear bridge, a tail hook of the carrier aircraft hooks a arresting cable, so that the carrier aircraft rolls along the center line of the ramp of the stern side rear bridge;
15) the carrier aircraft rolls onto the aircraft carrier at an deceleration and lands, under the braking actions produced by the arresting cable, the friction force of the wheels, air resistance and the ramp slope of the ramp of the stern side rear bridge;
16) the carrier aircraft with remaining speed rolls, at a decelerates, onto the treadmill belt-type runway which moves rapidly in reverse direction, and then the carrier aircraft is braked to halt on the on-deck runway at the rear part of the aircraft carrier under the braking action produced by the friction force of the wheels;
17) after a plurality of carrier aircrafts are landing, the elevating deck is operated to descend to its initial position, and the ramp of the stern side rear bridge, acting as a deck, is separated from the auxiliary ship and driven reversely to be retracted and repositioned; the aircraft carrier and the auxiliary ship are independent of each other, with traveling and parking respectively;
wherein during the steps of 12)-16), the auxiliary ship, together with the stern side rear bridge, is traveling with the aircraft carrier.
